(19) United States
(12) Patent Application Publication
(10) Pub. No.: US 2026/0220867 A1
(43) Pub. Date: Jul. 30, 2026

(54) GENERATIVE MODEL AND LATENT FRAME APPROXIMATION FOR MEDIA DATA GENERATION

(71) Applicant: QUALCOMM Incorporated, San Diego, CA (US)

(72) Inventors: Noor Fathima Khanum MOHAMED GHOUSE, Amsterdam (NL); Amir GHODRATI, Amsterdam (NL); Amirhossein HABIBIAN, Amsterdam (NL); Denis KORZHENKOV, Amsterdam (NL)

(21) Appl. No.: 19/036,614

(22) Filed: Jan. 24, 2025

(51) Int. Cl. G06T 13/80

(52) U.S. Cl. CPC G06T 13/80

(57) ABSTRACT

A device includes one or more processors coupled to a memory configured to store a generative model associated with a diffusion operation. The one or more processors are configured to generate, based on and input image frame, a time sequence of multiple latent image frames, and perform a first sampling operation of multiple sampling operations. To perform the first sampling operation, the one or more processors are configured to receive a first input version of frames of the multiple latent image frames, and output a first output version of frames of the multiple latent image frames. The first output version of frames includes the first output subset of frames generated based on a diffusion operation performed on a portion of the first input version of frames, and includes the second output subset of frames generated based on the first output subset of frames and the first input version of frames.

### I. FIELD

The present disclosure is generally related to generation of media data associated with a generative model.

### II. DESCRIPTION OF RELATED ART

Advances in technology have resulted in smaller and more powerful computing devices. In artificial intelligence (AI), generative models have been used in computer vision, audio, reinforcement learning, and computational biology. For example, with reference to computer vision applications, generative models, such as diffusion models, can be used for a variety of tasks or operations, such as image denoising, inpainting, super-resolution, image generation, and video generation. As another example, in other applications, generative models (e.g., diffusion models) have been applied to natural language processing tasks or operations, such as text generation and summarization, sound generation, and reinforcement learning. The generative models may have a variety of architectures, such as a U-Net architecture or a transformer architecture.

For video diffusion, a series of spatially and temporally consistent frames is typically generated by running a denoising diffusion sampling process. Video generation using the denoising diffusion sampling process can be compute intensive. For example, to generate fourteen frames that each have a resolution of 576 pixels×1024 pixels, a video diffusion process may include multiple denoising operations, such as a stable video diffusion process having twenty-five denoising operations, each denoising operation can have a cost of approximately ninety tera floating point operations (TFLOPs). Several techniques have been proposed to improve sampling efficiency of video diffusion models; however, these techniques require finetuning with high quality video data and require additional training compute.

### III. SUMMARY

According to one implementation of the present disclosure, a device includes a memory configured to store a generative model and includes one or more processors. The one or more processors are configured to obtain an input image frame, and generate, based on the input image frame, a time sequence of multiple latent image frames. The one or more processors are also configured to, for a first sampling operation of multiple sampling operations: receive a first input version of the multiple latent image frames, perform a diffusion operation, based on the generative model, on a first subset of the first input version of the multiple latent image frames to generate a first output subset of the multiple latent image frames, generate a second output subset of the multiple latent image frames based on the first input version of the multiple latent image frames and based on the first output subset of the multiple latent image frames, and output a first output version of the multiple latent image frames. The first output version includes the first output subset and the second output subset. The one or more processors are further configured to output, based on the multiple sampling operations, multiple output image frames associated with the input image frame.

According to another implementation of the present disclosure, a method includes obtaining an input image frame, and generating, based on the input image frame, a time sequence of multiple latent image frames. The method also includes, for a first sampling operation of multiple sampling operations, receiving a first input version of the multiple latent image frames, performing a diffusion operation, based on a generative model, on a first subset of the first input version of the multiple latent image frames to generate a first output subset of the multiple latent image frames, generating a second output subset of the multiple latent image frames based on the first input version of the multiple latent image frames and based on the first output subset of the multiple latent image frames, and outputting a first output version of the multiple latent image frames. The first output version includes the first output subset and the second output subset. The method further includes outputting, based on the multiple sampling operations, multiple output image frames associated with the input image frame.

According to another implementation of the present disclosure, a non-transitory computer-readable medium stores instructions that are executable by one or more processors to cause the one or more processors to obtain an input image frame. The instructions further cause the one or more processors to generate, based on the input image frame, a time sequence of multiple latent image frames. The instructions also cause the one or more processors to, for a first sampling operation of multiple sampling operations, receive a first input version of the multiple latent image frames, perform a diffusion operation, based on a generative model, on a first subset of the first input version of the multiple latent image frames to generate a first output subset of the multiple latent image frames, generate a second output subset of the multiple latent image frames based on the first input version of the multiple latent image frames and based on the first output subset of the multiple latent image frames, and output a first output version of the multiple latent image frames. The first output version includes the first output subset and the second output subset. The instructions further cause the one or more processors to output, based on the multiple sampling operations, multiple output image frames associated with the input image frame.

According to another implementation of the present disclosure, an apparatus includes means for obtaining an input image frame. The apparatus also includes means for generating, based on the input image frame, a time sequence of multiple latent image frames. The apparatus further includes means for performing a first sampling operation of multiple sampling operations. The means for performing the first sampling operation includes: means for receiving a first input version of the multiple latent image frames, means for performing a diffusion operation, based on a generative model, on a first subset of the first input version of the multiple latent image frames to generate a first output subset of the multiple latent image frames, means for generating a second output subset of the multiple latent image frames based on the first input version of the multiple latent image frames and based on the first output subset of the multiple latent image frames, and means for outputting a first output version of the multiple latent image frames. The first output version includes the first output subset and the second output subset. The apparatus includes means for outputting, based on the multiple sampling operations, multiple output image frames associated with the input image frame.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram of an example of a system to generate media data, in accordance with one or more aspects of the present disclosure.

FIG. 2 is a diagram to illustrate an example of multiple sampling operations associated with generation of media data, in accordance with some aspects of the present disclosure.

FIG. 3 is a diagram to illustrate an example of different sampling schemes associated with generation of media data, in accordance with some aspects of the present disclosure.

FIG. 4 is a block diagram of a particular illustrative aspect of a system that is operable to generate media data, in accordance with some aspects of the present disclosure.

FIG. 5 is a diagram of an example of an integrated circuit operable to generate media data, in accordance with some aspects of the present disclosure.

FIG. 6 is a diagram of a mobile device operable to generate media data, in accordance with some aspects of the present disclosure.

FIG. 7 is a diagram of a wearable electronic device operable to generate media data, in accordance with some aspects of the present disclosure.

FIG. 8 is a diagram of a voice-controlled speaker system operable to generate media data, in accordance with some aspects of the present disclosure.

FIG. 9 is a diagram of a camera operable to generate media data, in accordance with some aspects of the present disclosure.

FIG. 10 is a diagram of a headset, such as a virtual reality, mixed reality, or augmented reality headset, operable to generate media data, in accordance with some aspects of the present disclosure.

FIG. 11 is a diagram of a mixed reality or augmented reality glasses device operable to generate media data, in accordance with some aspects of the present disclosure.

FIG. 12 is a diagram of a first example of a vehicle operable to generate media data, in accordance with some examples of the present disclosure.

FIG. 13 is a diagram of a second example of a vehicle operable to generate media data, in accordance with some aspects of the present disclosure.

FIG. 14 is a diagram of an example of a method of generating media data, in accordance with some aspects of the present disclosure.

FIG. 15 is a block diagram of an illustrative example of a device that is operable to generate media data, in accordance with one or more aspects of the present disclosure.

### V. DETAILED DESCRIPTION

The above-described problems associated with use of generative models are solved using an approximator to generate at least one latent frame output during at least one sampling operation of multiple sampling operations as described herein. The present disclosure provides systems, devices, apparatus, methods, and computer-readable media for performing multiple sampling operations (e.g., multiple sampling steps) on a time sequence of multiple latent image frames. In some aspects, a device (e.g., a media generator) is configured to perform the multiple sampling operations based on an input image frame. To perform the multiple sampling operations, the media generator generates multiple latent image frames based on the input image frame. A first sampling operation of the multiple sampling operations is performed on a first version of the multiple latent image frames to generate a second version of the multiple image frames. The first sampling operation is performed using a generative model (e.g., an image-to-video generative model) and an approximator. The approximator is configured to generate an approximation of an output of a denoising operation for at least one latent image frame.

To perform the first sampling operation, a diffusion operation is performed, based on the generative model, on a first subset of the first input version of the multiple latent image frames to generate a first output subset of the second version of the multiple latent image frames, and an approximation operation is performed, based on the approximator, on a second subset of the first input version of the multiple latent image frames to generate a second output subset of the second version of the multiple latent image frames. In some embodiments, the first version is output from a preceding sampling operation and the approximator is configured to generate the first output subset based on the first version (e.g., the first subset and the second subset of the first version) and the first output subset. Accordingly, the approximator uses latent frames from a preceding denoising operation to approximate the second subset. To avoid error propagation and maintain quality control of the generation of different versions of the multiple image frames, the approximator may be applied (e.g., used) periodically in a subset of operations of the multiple sampling operations.

Particular implementations of the subject matter described in this disclosure can be implemented to realize one or more of the following potential technical advantages. In some aspects, the present disclosure provides techniques for generation of media data (e.g., video data) that includes or is based on one or more latent frame approximation operations, such as one or more training-free latent approximation operations. The techniques described herein can approximate (e.g., predict) a subset of latent frames at one or more sampling operations and can be implemented in conjunction with a variety of video diffusion models, schedules, and/or conventional techniques to improve sampling efficiency of video diffusion models. Additionally, the techniques described herein can perform the multiple sampling operations using the generative model and/or the approximator to generate video data that would otherwise take longer and be more computationally expensive as compared to conventional techniques which only use the same generative model for each sampling operation of the multiple sampling operations. For example, as compared to the conventional techniques, the techniques described herein can reduce a cost (e.g., an amount of time and/or power consumption) of video generation by approximately sixteen to twenty-seven percent with little to no loss in temporal consistency and video quality. The techniques may be used for video content generation and editing at a device (e.g., a camera or a phone), large scale video generation to train or evaluate a perception model (e.g., an automotive perception model), or large-scale video generation to train or evaluate models (e.g., extended reality (XR) models), as illustrative, non-limiting examples.

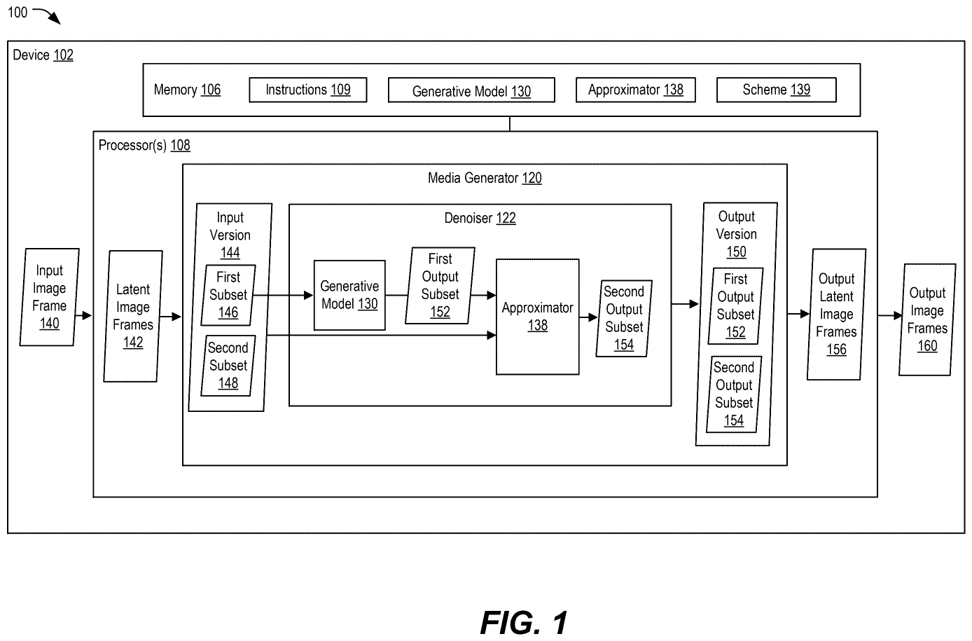

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a device 102 including one or more processors (“processor(s)” 108 of FIG. 1), which indicates that in some implementations the device 102 includes a single processor 108 and in other implementations the device 102 includes multiple processors 108. For ease of reference herein, such features are generally introduced as “one or more” features and are subsequently referred to in the singular or optional plural (as indicated by “(s)”) unless aspects related to multiple of the features are being described.

In some drawings, multiple instances of a particular type of feature are used. Although these features are physically and/or logically distinct, the same reference number is used for each, and the different instances are distinguished by addition of a letter to the reference number. When the features as a group or a type are referred to herein—e.g., when no particular one of the features is being referenced, the reference number is used without a distinguishing letter. However, when one particular feature of multiple features of the same type is referred to herein, the reference number is used with the distinguishing letter.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “obtaining,” “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “obtaining,” “generating,” “calculating,” “estimating,” “using,” “selecting,” “accessing,” and “determining” may be used interchangeably. For example, “obtaining,” “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, the term “machine learning” should be understood to have any of its usual and customary meanings within the fields of computers science and data science, such meanings including, for example, processes or techniques by which one or more computers can learn to perform some operation or function without being explicitly programmed to do so. As a typical example, machine learning can be used to enable one or more computers to analyze data to identify patterns in data and generate a result based on the analysis. For certain types of machine learning, the results that are generated include data that indicates an underlying structure or pattern of the data itself. Such techniques, for example, include so called “clustering” techniques, which identify clusters (e.g., groupings of data elements of the data).

For certain types of machine learning, the results that are generated include a data model (also referred to as a “machine-learning model” or simply a “model”). Typically, a model is generated using a first data set to facilitate analysis of a second data set. For example, a first portion of a large body of data may be used to generate a model that can be used to analyze the remaining portion of the large body of data. As another example, a set of historical data can be used to generate a model that can be used to analyze future data.

Since a model can be used to evaluate a set of data that is distinct from the data used to generate the model, the model can be viewed as a type of software (e.g., instructions, parameters, or both) that is automatically generated by the computer(s) during the machine learning process. As such, the model can be portable (e.g., can be generated at a first computer, and subsequently moved to a second computer for further training, for use, or both). Additionally, a model can be used in combination with one or more other models to perform a desired analysis. To illustrate, first data can be provided as input to a first model to generate first model output data, which can be provided (alone, with the first data, or with other data) as input to a second model to generate second model output data indicating a result of a desired analysis. Depending on the analysis and data involved, different combinations of models may be used to generate such results. In some examples, multiple models may provide model output that is input to a single model. In some examples, a single model provides model output to multiple models as input.

Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, deep belief networks, etc. Variants of decision trees include, for example and without limitation, random forests, boosted decision trees, etc.

Since machine-learning models are generated by computer(s) based on input data, machine-learning models can be discussed in terms of at least two distinct time windows-a creation/training phase and a runtime phase. During the creation/training phase, a model is created, trained, adapted, validated, or otherwise configured by the computer based on the input data (which in the creation/training phase, is generally referred to as “training data”). Note that the trained model corresponds to software that has been generated and/or refined during the creation/training phase to perform particular operations, such as classification, prediction, encoding, or other data analysis or data synthesis operations. During the runtime phase (or “inference” phase), the model is used to analyze input data to generate model output. The content of the model output depends on the type of model. For example, a model can be trained to perform classification tasks or regression tasks, as non-limiting examples. In some implementations, a model may be continuously, periodically, or occasionally updated, in which case training time and runtime may be interleaved or one version of the model can be used for inference while a copy is updated, after which the updated copy may be deployed for inference.

In some implementations, a previously generated model is trained (or re-trained) using a machine-learning technique. In this context, “training” refers to adapting the model or parameters of the model to a particular data set. Unless otherwise clear from the specific context, the term “training” as used herein includes “re-training” or refining a model for a specific data set. For example, training may include so called “transfer learning.” In transfer learning a base model may be trained using a generic or typical data set, and the base model may be subsequently refined (e.g., re-trained or further trained) using a more specific data set.

A data set used during training is referred to as a “training data set” or simply “training data”. The data set may be labeled or unlabeled. “Labeled data” refers to data that has been assigned a categorical label indicating a group or category with which the data is associated, and “unlabeled data” refers to data that is not labeled. Typically, “supervised machine-learning processes” use labeled data to train a machine-learning model, and “unsupervised machine-learning processes” use unlabeled data to train a machine-learning model; however, it should be understood that a label associated with data is itself merely another data element that can be used in any appropriate machine-learning process. To illustrate, many clustering operations can operate using unlabeled data; however, such a clustering operation can use labeled data by ignoring labels assigned to data or by treating the labels the same as other data elements.

Training a model based on a training data set generally involves changing parameters of the model with a goal of causing the output of the model to have particular characteristics based on data input to the model. To distinguish from model generation operations, model training may be referred to herein as optimization or optimization training. In this context, “optimization” refers to improving a metric, and does not mean finding an ideal (e.g., global maximum or global minimum) value of the metric. Examples of optimization trainers include, without limitation, backpropagation trainers, derivative free optimizers (DFOs), and extreme learning machines (ELMs). As one example of training a model, during supervised training of a neural network, an input data sample is associated with a label. When the input data sample is provided to the model, the model generates output data, which is compared to the label associated with the input data sample to generate an error value. Parameters of the model are modified in an attempt to reduce (e.g., optimize) the error value. As another example of training a model, during unsupervised training of an autoencoder, a data sample is provided as input to the autoencoder, and the autoencoder reduces the dimensionality of the data sample (which is a lossy operation) and attempts to reconstruct the data sample as output data. In this example, the output data is compared to the input data sample to generate a reconstruction loss, and parameters of the autoencoder are modified to reduce (e.g., optimize) the reconstruction loss.

FIG. 1 is a block diagram of an example of a system 100 to generate media data, in accordance with one or more aspects of the present disclosure. The system 100 includes a device 102, such as a media device, that is configured to or is operable to generate the media data, such as the output image frames 160.

The device 102 includes a memory 106 and one or more processors 108 (referred to herein as a “processor 108”). The memory 106 may include one or more memories, such as a single memory or multiple different memories (of the same type or of different types). The memory 106 is configured to store instructions 109, a generative model 130, an approximator 138, and one or more schemes 139 (referred to herein as a “scheme 139”). The instructions 109, when executed by the processor 108, cause the processor 108 to perform one or more operations as described herein.

The generative model 130 is configured to generate media data, such as image data, video data, audio data, training data, or a combination thereof. In the embodiment shown in FIG. 1, the generative model 130 is an image-to-video generative model and is configured to generate the output image frames 160, such as video data. In some examples, the generative model 130 includes a diffusion model, such as a stable diffusion model—e.g., a stable video diffusion model. To illustrate, the generative model 130 may be a latent diffusion model that is configured to perform image synthesis in a latent space with a relatively low computational demand as compared to image synthesis performed in a pixel space. In some embodiments, the generative model 130 has a U-Net architecture. The generative model 130 may be used or applied during one or more sampling operations as described further herein.

The approximator 138 is configured to obtain an input latent image frame and generate an output latent image frame that is an approximation of an output of a denoising operation performed on a latent image frame. For example, the approximator 138 is configured to obtain an input latent image frame and to determine the approximation of the output latent image frame based on the input latent image frame as described further herein. In some implementations, the approximator 138 is configured to perform an interpolation operation based on another latent image frame (e.g., an input version of the other latent image frame and an output version of the other latent image frame) to determine a change value, and approximate the output latent image frame based on the input latent image and the change value, as described further herein. To illustrate, the interpolation operation may include a linear interpolation operation.

The scheme 139 indicates or includes one or more schemes or patterns for sampling operations (e.g., sampling steps) associated with denoising operations. The scheme 139 may indicate, for multiple sampling operations, which sampling operation(s) of the multiple sampling operations are to use the approximator 138. Additionally, or alternatively, the scheme 139 may indicate, for a sampling operation that uses the approximator 138, which latent image frames (of the latent image frames 142) are to be sampled (e.g., denoised) using the approximator 138. For example, the latent image frames 142 may include a series (e.g., in the time domain) of image frames, and each latent frame includes or is associated with a frame index value that indicates a position of the latent frame in the series of image frames. The scheme 139 may indicate, for a sampling operation that uses the approximator 138, one or more frame index values of latent frames that are to be sampled (e.g., denoised) using the approximator 138. Additionally, or alternatively, the scheme 139 optionally may include or indicate one or more values to be used by the approximator 138, such as a weight value, as described further herein.

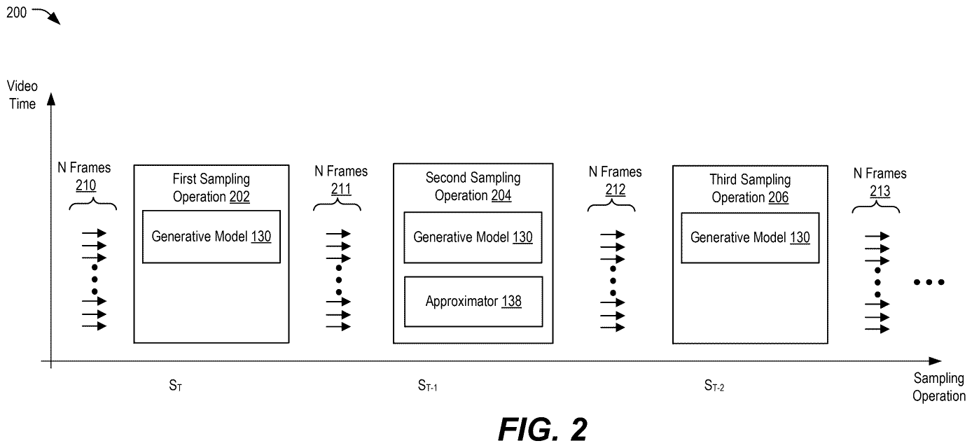

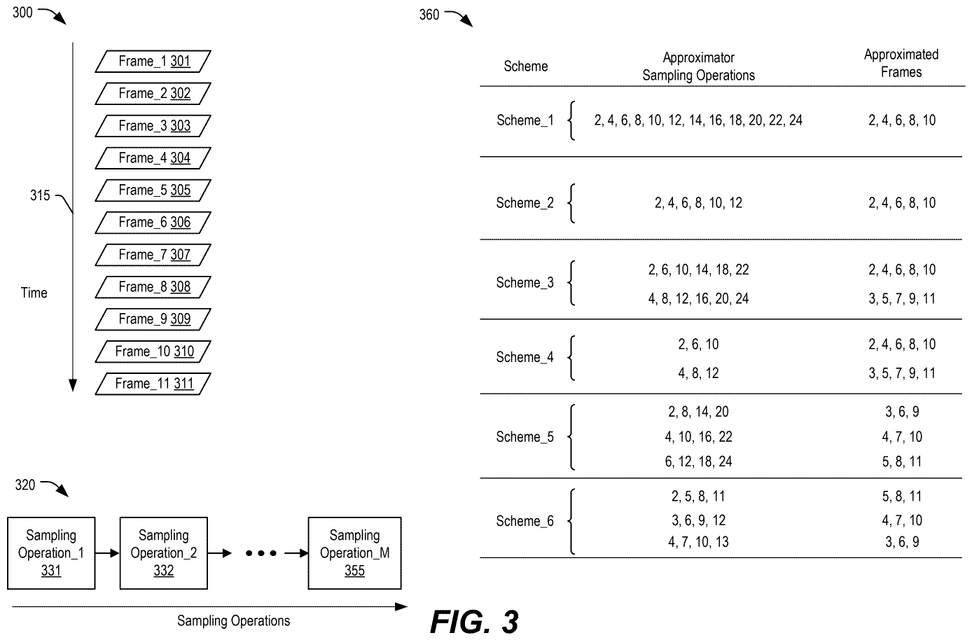

In some implementations, the scheme 139 indicates, for each sampling operation of the multiple sampling operations, whether to use the generative model 130 during the sampling operation or whether to use the generative model 130 and the approximator 138 during the sampling operation. For example, a first set of sampling operations that use the generative model 130 and the approximator 138 may be interleaved within a second set of sampling operations that use the generative model 130. In some embodiments, the generative model 130 and the approximator 138 may not be used for two consecutive sampling operations of the multiple sampling operations, may not be used for an initial sampling operation of the multiple sampling operations, or a combination thereof. Additionally, or alternatively, two or more consecutive sampling operations that use the generative model 130 may be performed between two sampling operations that each use the generative model 130 and the approximator 138. In some embodiments, two or more consecutive sampling operations that use the generative model 130 and the approximator 138 may not use the approximator 138 on latent image frames having the same frame index value for two consecutive sampling operations. Examples of different schemes 139 are described further herein at least with reference to FIGS. 2 and 3.

In some examples, the memory 106 stores other data. The other data may include image data, the media data generated by the processor 108, one or more additional models, or a combination thereof. For example, the one or more additional models may include a model to determine a weight value. For example, the model may select the weight value based on an input (e.g., a text input or a speech input), a scene (e.g., a type of the scene) of an input image frame 140, or a combination thereof. The type of the scene of the input image frame 140 may be an outdoor scene, an indoor scene, a low-light scene, a close-up scene, or another type of scene. In some embodiments, the weight value may be used by the approximator 138 to determine an amount of change to be applied to a latent image frame to generate a denoised approximation of the latent image frame.

The processor 108 includes a media generator 120. The media generator 120 includes a denoiser 122. Each of the media generator 120, the denoiser 122, or portions thereof, may be implemented by the processor 108 executing instructions (e.g., software), dedicated hardware (e.g., circuitry), or a combination thereof.

In some embodiments, the media generator 120 (e.g., the denoiser 122) is configured to receive input media data (e.g., the input image frame 140) and generate output media data (e.g., the output image frames 160). To illustrate, the media generator 120 (e.g., the denoiser 122) may include the generative model 130, the approximator 138, another model, or a combination thereof. For example, the media generator 120 (e.g., the denoiser 122) may be configured to obtain the generative model 130, the approximator 138, another model, or a combination thereof, from the memory 106.

The media generator 120 is configured to perform one or more media generation operations to generate media data, such as image data, audio data, video data (e.g., output image frames 160), game data, graphics data, or a combination thereof, as illustrative, non-limiting examples. In some embodiments, the one or more media generation operations include one or more video generation operations associated with generation of video content. For example, the one or more video generation operations may include or correspond to denoising, image-based video generation, a text-based video generation, text-based video content editing, video enhancement (e.g., super-resolution, colorization, etc.), video compression, or data augmentation for model training and evaluation.

The denoiser 122 is configured to perform multiple sampling operations (e.g., sampling steps), such as a series of sampling operations. Each sampling operation of the multiple sampling operations may use a model, such as the generative model 130. Additionally, or alternatively, a subset of the multiple sampling operations may use the generative model 130 and the approximator 138. In some embodiments, the multiple sampling operations include multiple denoising operations, such as multiple diffusion denoising functions, performed on noise data (e.g., a noise vector) to generate denoised data. In various embodiments, the multiple sampling operations include twelve sampling operations, twenty-five sampling operations, more than twenty-five sampling operations, or another number of sampling operations, as illustrative, non-limiting examples.

The multiple sampling operations can be performed on a series of image frames, such as latent image frames 142, that are each based on the input image frame 140. In various embodiments, the latent image frames 142 include fourteen latent image frames, as an illustrative, non-limiting example. Additionally, or alternatively, the latent image frames 142 include a series (e.g., in the time domain) of image frames. In some examples, the latent image frames 142 are indexed, and each latent frame includes or is associated with a frame index value that indicates a position of the latent frame in the series of image frames.

The media generator 120 (e.g., the denoiser 122) performs multiple sampling operations on the latent image frames 142 to generate output latent image frames 156. For example, each of the multiple sampling operations may generate a version (e.g., a denoised version) of the latent image frames 142. For example, an initial sampling operation (e.g., a first sampling operation) may be performed on the latent image frames 142 to generate a first output version of the latent image frames 142. The first output version may be provided to a next sampling operation (e.g., a second sampling operation of the multiple sampling operations). The second sampling operation may be performed to generate a second output version of the latent image frames 142. The second output version may be provided to a next sampling operation (e.g., a third sampling operation of the multiple sampling operations that is a sequentially next sampling operation). For each sampling operation of the multiple sampling operations, an output version (of the latent image frames 142) may be provided to a next sampling operation of the multiple sampling operations until a final sampling operation of the multiple sampling operations. An output version of the final sampling operation may be provided as an output (e.g., the output latent image frames 156) of the media generator 120.

In some implementations, the denoiser 122 performs a sampling operation that uses the generative model 130 and the approximator 138. The denoiser 122 may determine, based on the scheme 139, to use the generative model 130 and the approximator 138 for the sampling operation. The sampling operation may be performed on an input version 144 of the latent image frames 142 that includes a first subset 146 of latent image frames (of the latent image frames 142) and a second subset 148 of latent image frames (of the latent image frames 142). The denoiser 122 may identify the first subset 146 and the second subset 148 based on the scheme 139. The denoiser 122 may perform the sampling operation to generate an output version 150 of the latent image frames 142. The output version 150 may include a first output subset 152 of image frames (of the latent image frames 142) and a second output subset 154 of image frames (of the latent image frames 142). The first output subset 152 may be a denoised version of the first subset 146 and may be generated based on the first subset 146 and the generative model 130. The second output subset 154 may be an approximated denoised version of the second subset 148 and may be generated based on the approximator 138.

The approximator 138 may use a function L_{φ} configured to approximate one or more latent frames. The approximator 138 may receive (as inputs) the input version 144 (e.g., the first subset 146 and the second subset 148) and the first output subset 152. The function La may be defined as a linear interpolation in which:

$$the second output subset 154 = the second subset 148 + α * δ ,$$

where αϵ[0, 1] is a weight value (e.g., a tuning value), and δ indicates an amount of change between consecutive sampling operations. For example, a value of δ may indicate an amount of change associated with a least one frame index value. To illustrate, the value of δ may be defined as δ=the first output subset 152—the first subset 146. In some embodiments, the approximator 138 (e.g., the function L_{φ}) does not require training. Additionally, or alternatively, the function L_{φ} may be a non-parametric function (e.g., a non-parametric interpolation function) that estimates (e.g., approximates) the second output subset 154 based on an interpolation of the change between the first output subset 152 and first subset 146 without assuming a specific mathematical equation (e.g., without assuming a specific underlying distribution or functional form of the amount of change).

The value of a may be determined for the multiple sampling operations, or determined individually for one or more sampling operations. Additionally, or alternatively, the value of α may be a static value (e.g., the value of α does not change during the multiple sampling operations) or a dynamic value (e.g., the value of α is different for at least two sampling operations of the multiple sampling operations). In some implementations, the value of α is a default value (e.g., a default value for the multiple sampling operations or for one or more individual sampling operations) that is indicated by the scheme 139. For example, the scheme 139 may indicate a value of α to be used for the multiple sampling operations or may indicate a respective value a to be applied for each sampling operation of the multiple sampling operations for which the approximator 138 is used. In implementations in which a is a default value or is not included in the function L_{φ}, the function L_{φ} may be considered a non-parametric function.

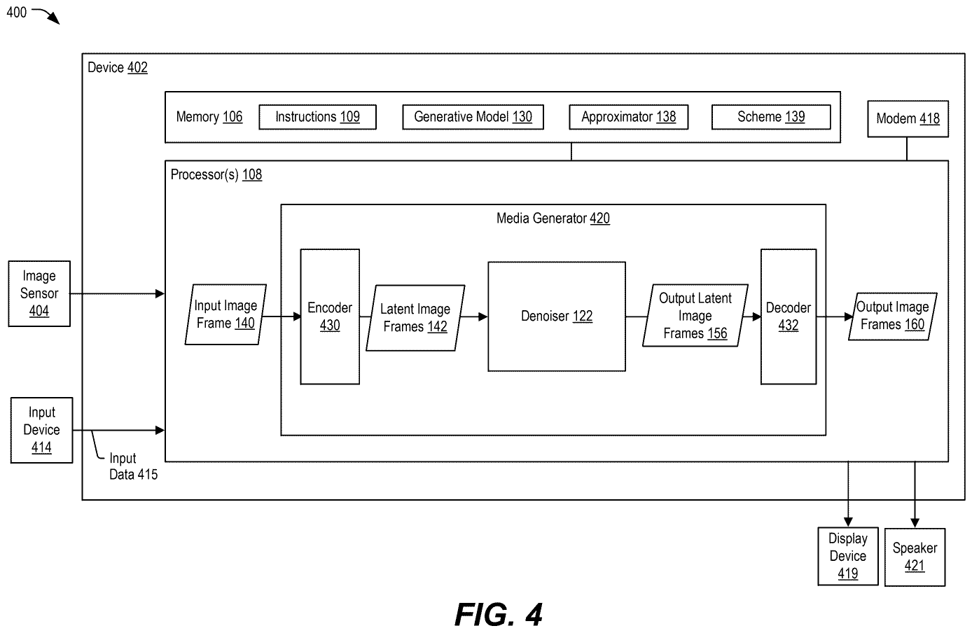

In some embodiments, the value of α may be determined based on a model. For example, the model may determine the value of α for at least one sampling operation of the multiple sampling operations. To illustrate, the model may determine the value of α based on the input image frame 140 (e.g., a type, category, an image characteristic (e.g., brightness, resolution, etc.) of the input image frame 140), a number of sampling operations performed or to be performed, an amount of motion to be generated in video content, or a combination thereof. Additionally, or alternatively, the value of α may be determined based on an input, as described further herein at least with reference to FIG. 4.

In some embodiments, the value of α may change (e.g., increase) during the multiple sampling operations. To illustrate, earlier sampling operations of the multiple sampling operations may be associated with low frequency content (e.g., high-level structure of video content) and later sampling operations may be associated with high frequency content (e.g., detailed structure of the video content). For example, the high-level details may be an object, such as a person or animal, and the detailed structure may be associated with details of the object, such as hair or skin of the object. In some embodiments, the value of α may be increased over the multiple sampling operations to improve temporal consistency and video quality of generated video content.

In some embodiments, a value of δ is determined to indicate an amount of change for a single frame index value. Additionally, or alternatively, the value of δ is determined as an average of the difference between the first output subset 152 and the first subset 146. To illustrate, a first difference may be determined for a first latent frame (having a first frame index value) of the latent image frames 142, and a second difference may be determined for a second latent frame (having a second frame index value) of the latent image frames 142. The value of δ may then be determined as an average of the first difference and the second difference. The same value of δ may then be used for each latent image frame of the second subset 148. As another example, a value of δ may be determined for each respective latent image frame of the second subset 148. To illustrate, for each latent image frame of the second subset 148, a closest or an adjacent latent image frame from the first subset 146 may be identified that is earlier in time (e.g., has a lower frame index value) from the latent image frame, and the value of δ is determined based on the closest or the adjacent latent image frame from the first subset 146. In some such examples, the value of δ is determined as the difference between the identified closest or adjacent latent image of the first subset 146 and a corresponding latent image frame of the first output subset 152.

In some embodiments, the denoiser 122 is configured to perform the multiple sampling operations based on or according to the scheme 139. The scheme 139 may indicate, for each sampling operation of the multiple sampling operations, whether to use the generative model 130 during the sampling operation or whether to use the generative model 130 and the approximator 138 during the sampling operation. For example, use of the approximator 138 may be interleaved in between sampling operations that use the generative model 130 (and that do not use the approximator 138). In some embodiments, the generative model 130 and the approximator 138 may not be used together for two consecutive sampling operations of the multiple sampling operations, may not be used together for an initial sampling operation of the multiple sampling operations, or a combination thereof. Additionally, or alternatively, two or more consecutive sampling operations that each use the generative model 130 may be performed between two sampling operations that each use the generative model 130 and the approximator 138. In some embodiments, two or more consecutive sampling operations that each use the generative model 130 and the approximator 138 may not use the approximator 138 on latent image frames having the same frame index value for two consecutive sampling operations. Examples of different schemes 139 are described further herein at least with reference to FIGS. 2 and 3.

In some embodiments, the processor 108 (e.g., the media generator 120) is configured to determine (e.g., calculate or select) a weight value (e.g., α) associated with the approximator 138. For example, the processor 108 (e.g., the media generator 120) is configured to determine (e.g., calculate or select) a weight value based on a model, the input image frame 140, an input, or a combination thereof. The weight value may be determined (e.g., calculated or selected) for a set of sampling operations, such as one or more sampling operations. For example, a single weight value may be calculated or selected for multiple sampling operations, or a respective weight value may be calculated or selected for each sampling operation of multiple sampling operations. In some other embodiments, the processor 108 is configured to identify the weight value (e.g., α) that is a default weight value indicted by the scheme 139.

In some embodiments, the media generator 120 includes an encoder, a decoder, or both, as described further herein at least with reference to FIG. 4. The encoder is configured to receive the input image frame 140 and generate the latent image frames 142 (e.g., one or more latent representations) based on the input image frame 140. The latent image frames 142 may be provided to the media generator 120 (e.g., the denoiser 122) to perform the multiple sampling operations. An output of the media generator 120 (e.g., the denoiser 122), such as the output latent image frames 156 may be provided to the decoder, which is configured to generate the output image frames 160 based on the output latent image frames 156. For example, the decoder may receive and decode a final version (e.g., the output version 150 or the output latent image frames 156) of the multiple latent image frames 142 based on the multiple sampling operations to generate the output image frames 160. In some embodiments, the processor 108 (e.g., the media generator 120) includes an autoencoder and the auto encoder includes the encoder and the decoder.

During operation, the processor 108 (e.g., the media generator 120) obtains the input image frame 140. The processor 108 generates, based on the input image frame 140, the latent image frames 142, such as a time sequence of the latent image frames 142. For example, the processor 108 may include an encoder that is configured to generate the latent image frames 142 based on the input image frame 140.

The processor 108 (e.g., the denoiser 122) performs multiple sampling operations (e.g., multiple sampling steps) based on the input image frame 140. For example, the processor 108 (e.g., the denoiser 122) performs the multiple sampling operations based on the latent image frames 142. In some embodiments, to perform one or more of the multiple sampling operations, the processor (e.g., the media generator 120) may identify the scheme 139 to be used for the multiple sampling operations, the latent image frames 142, or a combination thereof.

Based on the multiple sampling operations, the processor 108 (e.g., the denoiser 122) provides the output latent image frames 156. Additionally, the processor 108 (e.g., the media generator 120) outputs the output image frames 160 based on the multiple sampling operations performed by the denoiser 122. For example, the processor 108 (e.g., the media generator 120) may output the output image frames 160 based on the output latent image frames 156. In some embodiments, the processor 108 (e.g., the media generator 120) outputs, as the output image frames 160, fourteen or more image frames (associated with the input image frame 140). The multiple output image frames 160 may include a time sequence of the output image frames 160, such as video content.

In some embodiments, to perform the multiple sampling operations, the media generator 120 (e.g., the denoiser 122) obtains the generative model 130, the approximator 138, or a combination thereof. The media generator 120 (e.g., the denoiser 122) performs a first sampling operation (of the multiple sampling operations) based on the generative model 130 and the approximator 138. To perform the first sampling operation, the media generator 120 (e.g., the denoiser 122) receives the input version 144 of the latent image frames 142. The input version 144 may be the same as the latent image frames 142 or may be a denoised version of the latent image frames 142. The input version 144 may include the first subset 146 (e.g., a first subset of latent image frames) of the input version 144 and the second subset 148 (e.g., a second subset of latent image frames) of the input version 144. The first subset 146 may be distinct from the second subset 148 such that none of the latent image frames included in the first subset 146 are included in the second subset 148, and vice versa. The media generator 120 (e.g., the denoiser 122) performs the first sampling operation to generate the output version 150 (e.g., an output version of latent image frames) of the first sampling operation. The output version 150 is a denoised version of the input version 144 and is associated with the latent image frames 142. The output version 150 includes the first output subset 152 (e.g., a first output subset of latent image frames) and the second output subset 154 (e.g., a second subset of latent image frames). As described further herein, the first output subset 152 corresponds to a denoised version of the first subset 146, and the second output subset 154 corresponds to an approximation of a denoised version of the second subset 148.

As part of the first sampling operation, the denoiser 122 performs a diffusion operation, based on the generative model 130, on the first subset 146 of the input version 144 to generate the first output subset 152 (e.g., a first output subset of latent image frames) of the output version 150 that is associated with the latent image frames 142. Additionally, as part of the first sampling operation, the denoiser 122 generates the second output subset 154 based on the input version 144 and based on the first output subset 152. For example, the denoiser 122 may use the approximator 138 to generate the second output subset 154 based on the input version 144 and the first output subset 152. The second output subset 154 may be an approximation of an output subset of frames that would be generated if the denoiser 122 performed the diffusion operation, using the generative model 130, on the second subset 148.

In some embodiments, to generate the second output subset 154, the denoiser 122 (e.g., the approximator 138) interpolates the second output subset 154 based on the input version 144 and the first output subset 152. For example, to interpolate the second output subset 154, the denoiser 122 (e.g., the approximator 138) determines a change value, such as a value of δ, based on the first subset 146 and the first output subset 152. The denoiser 122 (e.g., the approximator 138) may also determine a weight value, such as a value of α, and modify the change value based on the weight value. The second output subset 154 can be generated based on the change value (or the modified change value) and the second subset 148 of the input version 144.

Based on or as part of the first sampling operation, the denoiser 122 outputs the output version 150 that includes the first output subset 152 and the second output subset 154. In some embodiments, the output version 150 of the first sampling operation may be provided as an input to a next (e.g., subsequent) sampling operation of the multiple sampling operations. Alternatively, in other embodiments, the output version 150 may be provided by the media generator 120 as the output latent image frames 156—e.g., an output of the multiple sampling operations.

The processor 108 outputs, based on the multiple sampling operations, the output image frames 160 associated with the input image frame 140. For example, the processor 108 may include a decoder that decodes a final version (e.g., the output version 150 or the output latent image frames 156) of the multiple latent image frames 142 based on the multiple sampling operations to generate the output image frames 160.

The media generator 120 (e.g., the denoiser 122) also performs a second sampling operation (of the multiple sampling operations) based on the generative model 130. To perform the second sampling operation, the media generator 120 (e.g., the denoiser 122) receives a second input version of the latent image frames 142 and performs the diffusion operation (based on the generative model 130) on the second input version (of the latent image frames 142) to generate a second output version of the latent image frames 142. Based on or as part of the second sampling operation, the denoiser 122 (e.g., the generative model 130) outputs the second output version of the latent image frames 142. In some embodiments, a first power consumption associated with performance of the first sampling operation is less than a second power consumption associated with performance of the second sampling operation.

The second sampling operation can be performed prior or subsequent to the first sampling operation. If the second sampling operation is performed immediately prior to the first sampling operation (e.g., the first sampling operation is a next sampling operation after the second sampling operation), and the second output version is provided as the first input version for the second sampling operation. In some embodiments, the second sampling operation is the initial sampling operation of the multiple sampling operations. Alternatively, if the second sampling operation is performed immediately after the first sampling operation (e.g., the second sampling operation is a next sampling operation after the first sampling operation), the first output version is provided as the second input version for the second sampling operation.

In some embodiments, the media generator 120 (e.g., the denoiser 122) performs a third sampling operation (of the multiple sampling operations) based on the generative model 130. For example, the media generator 120 (e.g., the denoiser 122) performs a third sampling operation to generate a third output version of the latent image frames 142. The third sampling operation may be a next sampling operation after the second sampling operation. Additionally, the third sampling operation may be performed prior to or subsequent to the first sampling operation. In some examples, the second sampling operation is performed after the first sampling operation, and the third sampling operation is performed after the second sampling operation.

To perform the third sampling operation, the media generator 120 (e.g., the denoiser 122) receives the second output version (of the second sampling operation) as a third input version of the latent image frames 142. The third input version may include a first subset (of latent image frames) and a second subset (of latent image frames).

As part of the first sampling operation, the denoiser 122 performs a diffusion operation, based on the generative model 130, on the first subset of the third input version to generate a third output subset of the third output version. Additionally, as part of the third sampling operation, the denoiser 122 generates a second output subset of the third version based on the third input version and based on the third output subset of the third output version. For example, the denoiser 122 may use the approximator 138 to generate the fourth output subset based on the third input version and the third output subset of the third output version.

Based on or as part of the third sampling operation, the denoiser 122 outputs the third output version (of the latent image frames 142) that includes the third output subset and the fourth output subset. In some embodiments, the first subset of the first input version and the first subset of the third input version are associated with the same subset of latent image frames of the latent image frames 142. In other embodiments, the first subset of the first input version and the first subset of the third input version are associated with different subsets of latent image frames of the latent image frames 142.

In some embodiments, a device (e.g., the device 102) includes a memory (e.g., the memory 106) and one or more processors (e.g., the processor 108). The memory is configured to store a generative model (e.g., the generative model 130). The one or more processors are configured to obtain an input image frame (e.g., the input image frame 140), and generate, based on the input image frame, a time sequence of multiple latent image frames (e.g., the latent image frames 142). The one or more processors are also configured to, for a first sampling operation of multiple sampling operations: receive a first input version (e.g., the input version 144) of the multiple latent image frames, perform a diffusion operation, based on the generative model, on a first subset (e.g., the first subset 146) of the first input version of the multiple latent image frames to generate a first output subset (e.g., the first output subset 152) of the multiple latent image frames, generate a second output subset (e.g., the second output subset 154) of the multiple latent image frames based on the first input version of the multiple latent image frames and based on the first output subset of the multiple latent image frames, and output a first output version (e.g., the output version 150) of the multiple latent image frames. The first output version includes the first output subset and the second output subset. The one or more processors are further configured to output, based on the multiple sampling operations, multiple output image frames (e.g., output image frames 160) associated with the input image frame.

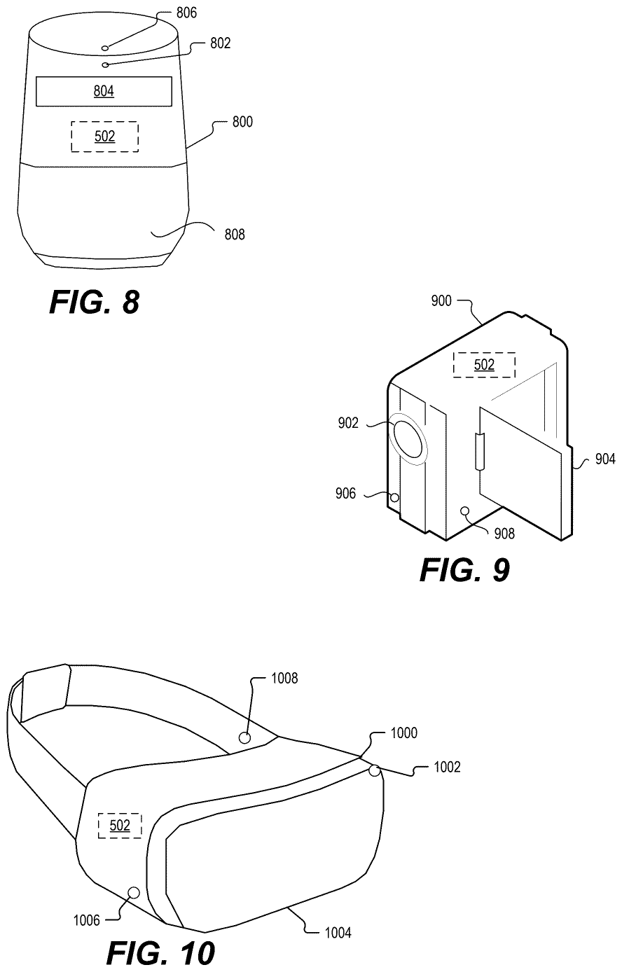

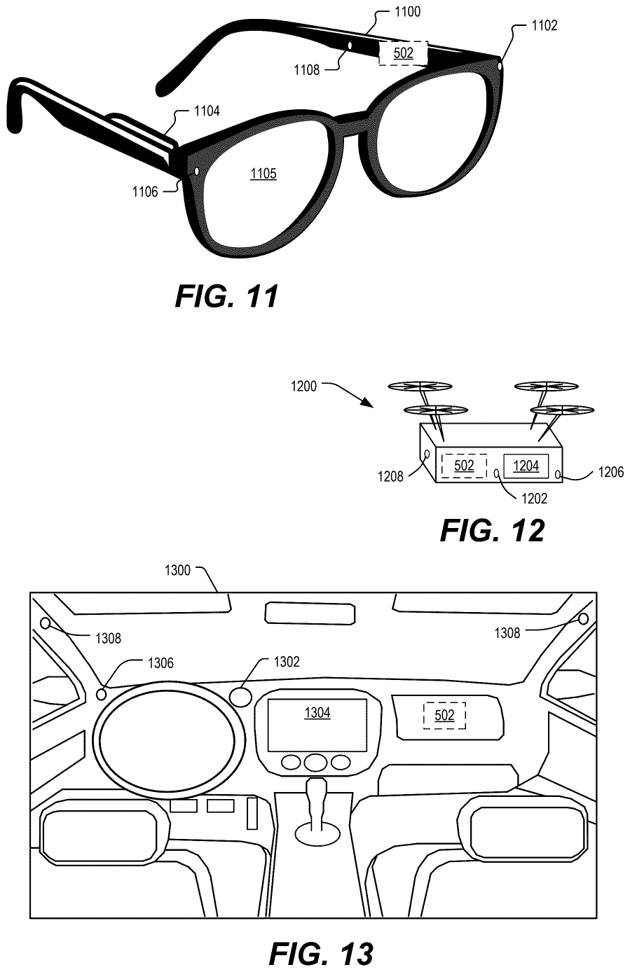

In some examples, the device 102 corresponds to or is included in one of various types of devices, such that the processor 108 can be integrated in multiple types of devices. In an illustrative example, the processor 108 is integrated in a wearable electronic device as depicted in FIG. 7, a virtual reality, mixed reality, or augmented reality headset as depicted in FIG. 10, a mixed reality or augmented reality glasses device as described with reference to FIG. 11, or another wearable device. In another illustrative example, the processor 108 is integrated in a mobile device (e.g., a mobile phone or a tablet) as depicted in FIG. 6, a voice-controlled speaker system as depicted in FIG. 8, a camera as depicted in FIG. 9, a vehicle as depicted in FIG. 12, a vehicle as depicted in FIG. 13, a computer or a server, or another system or device.

One technical advantage of implementing the device 102 as described above is that a sampling operation performed using the generative model 130 and the approximator 138 can be performed faster and conserve power as compared to a sampling operation performed using only the generative model 130. Additionally, the techniques described herein can perform the multiple sampling operations using the generative model 130 and/or the approximator 138 to generate video data that would otherwise take longer and be more computationally expensive as compared to conventional techniques which use the same generative model for each sampling operation of the multiple sampling operations. For example, as compared to the conventional techniques, the techniques described herein can reduce a cost (e.g., an amount of time and/or power consumption) of video generation by approximately sixteen to twenty-seven percent with little to no loss in temporal consistency and video quality.

FIGS. 2 and 3 are diagrams to illustrate examples of multiple sampling operations associated with generation of media data, in accordance with some aspects of the present disclosure. For example, FIG. 2 illustrates a first example 200 of multiple sampling operations associated with generation of media data (e.g., the output image frames 160) and FIG. 3 illustrates an example of different sampling schemes associated with generation of media data.

Referring to FIG. 2, the example 200 depicts multiple sampling operations along an x-axis and video time along a y-axis. The multiple sampling operations may be performed by the processor 108 (e.g., the media generator 120) of FIG. 1. The multiple sampling operations may include a total of T operations, where T is a positive integer greater than or equal to two. As an example, the multiple sampling operations may be performed by the denoiser 122 on multiple latent image frames, such as N frames, where N is a positive integer greater than or equal to two. In some embodiments, N is equal to fourteen or twenty-five, as illustrative, non-limiting examples. The multiple latent image frames may be based on or associated with an input image frame, such as the input image frame 140.

The multiple sampling operations include a first sampling operation (S_{T}) 202, a second sampling operation (S_{T-1}) 204, and a third sampling operation (S_{T-2}) 206. During the first sampling operation (S_{T}) 202 and the third sampling operation (S_{T-2}) 206, the denoiser 122 uses the generative model 130 (e.g., a first generative model). During the second sampling operation (S_{T-1}) 204, the denoiser 122 uses the generative model 130 and the approximator 138.

Each of the multiple sampling operations may be performed to generate a version (e.g., a denoised version) of the multiple latent image frames, such as the latent image frames 142. For example, N frames 210 may include or correspond to a first version (e.g., an initial version) of the multiple latent image frames. In some embodiments, the N frames 210 may include the latent image frames 142. The N frames 210 are provided as an input for the first sampling operation (S_{T}) 202.

The generative model 130 is applied to the N frames 210 at the first sampling operation (S_{T}) 202. The first sampling operation (S_{T}) 202 outputs N frames 211 which include or correspond to a second version (e.g., a first output version) of the multiple image frames. The N frames 211 are provided as an input to the second sampling operation (S_{T-1}) 204.

The modified generative model 130 and the approximator 138 are applied at the second sampling operation (S_{T-1}) 204. For example, the modified generative model 130 and the approximator 138 are applied based on or in accordance with the scheme 139. The second sampling operation (S_{T-1}) 204 outputs N frames 212 which include or correspond to a third version (e.g., a second output version) of the multiple image frames. For example, a first portion of the N frames 211 may be provided as an input to the generative model 130 to generate a first portion of the N frames 212. The first portion of the N frames 211 may include or correspond to the first subset 146, and the first portion of the N frames 212 may include or correspond to the first output subset 152. A second portion of the N frames 211 may be provided as an input to the approximator to generate a second portion of the N frames 212. The second portion of the N frames 211 may include or correspond to the second subset 148, and the second portion of the N frames 212 may include or correspond to the second output subset 154. Additionally, or alternatively, the first portion and the second portion of the N frames 211 may be identified or selected based on the scheme 139. In some embodiments, the first portion of the N frames 211 and the first portion of the N frames 212 are also provided to the approximator 138 for the approximator to generate the second portion of the N frames 212. The N frames 212 are provided as an input to the third sampling operation (S_{T-2}) 206.

The generative model 130 is applied at the third sampling operation (S_{T-2}) 206. The third sampling operation (S_{T-2}) 206 outputs N frames 213 which include or correspond to a fourth version (e.g., a third output version) of the multiple image frames. The N frames 213 may be provided as an input to a next sampling operation or as an output (e.g., the output latent image frames 156) of the denoiser 122.

It is noted that the scheme (e.g., the scheme 139) of the generative model 130 and/or the approximator 138 that are applied during the sampling operations of the embodiment of FIG. 2 is provided for illustrative purposes and that a different scheme or pattern may be performed. For example, the second sampling operations (S_{T-1}) may apply the generative model 130 and the third sampling operations (S_{T-2}) 206 may apply the generative model 130 and the approximator 138.

FIG. 3 is a diagram to illustrate an example of different sampling schemes associated with generation of media data, in accordance with some aspects of the present disclosure. FIG. 3 includes an example of latent image frames 300, an example of multiple sampling operations 320, and an example of multiple schemes 360.

The latent image frames 300 includes a time sequence of multiple latent image frames as indicated by a time axis 315. The latent image frames 300 may include or correspond to the latent image frames 142, the output latent image frames 156, or the N frames 210-213. The time sequence of the latent image frames 300 may include or correspond to media data, such as video data associated with video content. The latent image frames 300 include latent image frames 301-311, such as a first latent image frame (Frame_1) 301, a second latent image frame (Frame_2) 302, a third latent image frame (Frame_3) 303, a fourth latent image frame (Frame_4) 304, a fifth latent image frame (Frame_5) 305, a sixth latent image frame (Frame_6) 306, a seventh latent image frame (Frame_7) 307, an eighth latent image frame (Frame_8) 308, an ninth latent image frame (Frame_9) 309, a tenth latent image frame (Frame_10) 310, and an eleventh latent image frame (Frame_11) 311. In some embodiments, each latent image frame of the latent image frames 300 includes or is associated with a respective frame index value that indicates a position of the latent image frame in the series of the latent image frames 300. To illustrate, the first latent image frame (Frame_1) 301 may have a frame index value of one, the second latent image frame (Frame_2) 302 may have a frame index value of two, the third latent image frame (Frame_3) 303 may have a frame index value of three, etc.

In some embodiments, a latent image frame of the latent image frames 300 corresponds to a source frame, such as the input image frame 140. For example, the first latent image frame (Frame_1) 301 may include or correspond to the source frame. Although the embodiment of the latent image frames 300 of FIG. 3 is described as including eleven latent image frames, in other embodiments the latent image frames 300 may include a number of latent image frames other than eleven, such as fourteen latent image frames, as an illustrative, non-limiting example.

The multiple sampling operations 320 may be associated with one or more denoising operations. The multiple sampling operations 320 may be performed by the processor 108 (e.g., the media generator 120) of FIG. 1. The multiple sampling operations 320 may include or correspond to the sampling operations 202, 204, 206 of FIG. 2.

The multiple sampling operations 320 include a first sampling operation (sampling operation_1) 331, a second sampling operation (sampling operation_2) 332, and an Mth sampling operation (sampling operation_M) 355, where M is a positive integer greater than or equal to two. It is noted that although the multiple sampling operations 320 are shown in FIG. 3 as including three sampling operations, in embodiments, the multiple sampling operations 320 may include another number of sampling operations, such as twenty-five sampling operations, as an illustrative, non-limiting example. In some embodiments, each sampling operation of the multiple sampling operations 320 includes or is associated with a respective sampling operation index value that indicates a position of the sampling operation in the series of the multiple sampling operations 320. To illustrate, the first sampling operation (sampling operation_1) 331 may have a sampling operation value of one, the second sampling operation (sampling operation_2) 332 may have a sampling operation value of two, and the Mth sampling operation (sampling operation_M) 355 may have a sampling operation value of M.

Each sampling operation of the multiple sampling operations 320 may be performed to generate a version (e.g., a denoised version) of the multiple latent image frames 300. For example, the first sampling operation (sampling operation_1) 331 may be performed on the latent image frames 300 to generate a first output version of the latent image frames 300. The second sampling operation (sampling operation_2) 332 may be performed on the first output version to generate a second output version of the latent image frames 300. One or more additional sampling operations may similarly be performed and the Mth sampling operation (sampling operation_M) 355 may be performed to generate an Mth output version of the latent image frames. The Mth output version may include or correspond to the output version 150 or the output latent image frames 156.

In some embodiments, the multiple sampling operations 320 may be performed based on or in accordance with a scheme, such as the scheme 139, in which at least one sampling operation of the multiple sampling operations 320 uses an approximator (e.g., the approximator 138). In some embodiments, the at least one sampling operation may also be performed based on a generative model, such as the generative model 130.

In some embodiments, the scheme may include one of the multiple schemes 360. For example, the scheme may be selected from the multiple schemes 360. The multiple schemes 360 may include or correspond to the scheme 139. With reference to the multiple schemes 360, each of the multiple schemes 360 may be implemented with reference to the latent image frames 300 (e.g., eleven latent image frames) and to perform the multiple sampling operations 320 that include twenty-five sampling operations. Although the multiple schemes 360 are described with reference to eleven latent image frames and with reference to twenty-five sampling operations, each of the multiple schemes 360 are intended to be illustrative examples and other schemes are possible, such as one or more other schemes that may be implemented/used with a different number of latent image frames, a different number of sampling operations, or a combination thereof.

The multiple schemes 360 include six schemes, such as a first scheme (scheme_1), a second scheme (scheme_2), a third scheme (scheme_3), a fourth scheme (scheme_4), a fifth scheme (scheme_5), and a sixth scheme (scheme_6). Although six schemes are described with respect to the example of the multiple schemes 360 of FIG. 3, in other embodiments, the multiple schemes 360 may include a different number of schemes, such as one scheme, two schemes, or more than two schemes.

Each of the schemes of the multiple schemes 360 includes or indicates approximator sampling operations and approximated frames. The approximator sampling operations include or indicate a sampling operation index value of one or more sampling operations that are to be performed using an approximator, such as the approximator 138. The approximated frames include or indicate one or more frame index values of latent image frames (e.g., versions of the latent image frames) that are to be generated by the corresponding approximator. For example, referring to the second scheme (scheme_2), sampling operations having sampling operation index values of 2, 4, 6, 8, 10, and 12 are to be configured to use the approximator to generate latent image frames having frame index values of 2, 4, 6, 8, and 10. As another example, referring to the fourth scheme (scheme_2), sampling operations having sampling operation index values of 2, 6, and 10 are to be configured to use the approximator to generate latent image frames having frame index values of 2, 4, 6, 8, and 10, and sampling operations having sampling operation index values of 4, 8, and 12 are to be configured to use the approximator to generate latent image frames having frame index values of 3, 5, 7, 9, and 11. As another example, referring to the sixth scheme (scheme_6), sampling operations having sampling operation index values of 2, 5, 8, and 11 are to be configured to use the approximator to generate latent image frames having frame index values of 5, 8, and 11, sampling operations having sampling operation index values of 3, 6, 9, and 12 are to be configured to use the approximator to generate latent image frames having frame index values of 4, 7, and 10, and sampling operations having sampling operation index values of 4, 7, 10, and 13 are to be configured to use the approximator to generate latent image frames having frame index values of 3, 6, and 9.

In some embodiments, one or more schemes of the multiple schemes 360 may indicate a weight value (e.g., a value of α) to be used by the approximator 138 and/or may indicate a manner in which the weight value (e.g., the value of α) is to be determined. For example, at least one scheme of the multiple schemes 360 may indicate a default weight value to be applied by the approximator 138 for each sampling operation index value indicated by the approximator sampling operations heading. As another example, the at least one scheme may indicate a respective weight value for each sampling operation index value indicated by the approximator sampling operations heading. Additionally, or alternatively, one or more schemes of the multiple schemes 360 may indicate the manner in which a value of δ is determined. For example, at least one scheme of the multiple schemes 360 may indicate that the value of δ is to be determined based on a single frame index value or based on multiple frame index values.

FIG. 4 is a block diagram of a particular illustrative aspect of a system 400 that is operable to generate media data, in accordance with some aspects of the present disclosure. The system 400 includes a device 402 that may include or correspond to the device 102 of FIG. 1.

The device 402 includes the memory 106, the processor 108, and a modem 418. The modem 418 is coupled to the processor 108 and is configured to transmit video content (e.g., the output image frames 160) to a second device for output by the second device. Additionally, or alternatively, the modem is configured to receive an image frame (e.g., the input image frame 140), video content, a model (e.g., the generative model 130), the approximator 138, the scheme 139, audio data, or a combination thereof, from a second device. The memory 106 is configured to store the instructions 109, the generative model 130, the approximator 138, and the scheme 139. The instructions 109, when executed by the processor 108, cause the processor 108 to perform one or more operations as described herein.

The processor 108 is also coupled to an image sensor 404, an input device 414 (e.g., a microphone, a keyboard or touch screen, etc.), a display device 419, and a speaker 421. The image sensor 404 may include one or more cameras and may be configured to generate image data (e.g., an image frame), such as the input image frame 140. Media data, such as the output image frames 160 (e.g., video content), may be generated by the processor 108 at least partially based on the input image frame 140. The input device 414 is configured to receive an input and provide the input to the processor 108 as input data 415. For example, the input device 414 may include a keyboard, a touch screen, or a microphone configured to receive the input and provide the input data 415 (e.g., an input signal) to the processor 108. The input (e.g., the input data 415) may include or indicate a request to generate media data (e.g., video data), such as video content. Additionally, or alternatively, the input (e.g., the input data 415) may include or indicate the scheme 139, one or more approximator sampling operations, one or more approximated frames, a weight value (e.g., α) or a manner in which the weight value (e.g., α) is determined, a manner in which a change value (e.g., δ) is determined, or a combination thereof. In some examples, the input includes a request to perform an image-to video generation operation, text-based video generation operation, a text-based video content editing operation, a video enhancement operation, video compression, a data augmentation operation, or a combination thereof.

The display device 419 is coupled to the processor 108 and is configured to output video content (e.g., the output image frames 160) generated based on the input image frame 140. In some examples, the display device 419 includes a display screen, a monitor or television, a projector, or a combination thereof. In some embodiments, the device 402 may include or be coupled to a speaker 421 that is configured to output audio associated with video content (e.g., the output image frames 160) generated based on the input image frame 140.

The image sensor 404, the input device 414, the display device 419, the speaker 421, or a combination thereof, may be coupled to or integrated within the device 402. Although the device 402 is described as being coupled to or including the image sensor 404, the input device 414, the modem 418, the display device 419, and the speaker 421, in other embodiments the device 402 may not include or be coupled to the image sensor 404, the input device 414, the modem 418, the display device 419, the speaker 421, or a combination thereof. For example, the image sensor 404, the input device 414, the modem 418, the display device 419, the speaker 421, or a combination thereof, may be included in another device, such as a wearable device, which is configured to be coupled to the device 402.

The processor 108 of FIG. 4 includes the media generator 420. The media generator 420 may include or correspond to the media generator 120. The media generator 420 includes an encoder 430, the denoiser 122, and a decoder 432. The encoder 430 is configured to receive the input image frame 140 and generate the latent image frames 142 based on the input image frame 140. For example, the encoder 430 may include a neural network configured to extract latents (e.g., low dimensional representations). In some such examples, the encoder 430 performs one or more operations to compress the input image frame 140 into the latent space. To illustrate, the encoder 430 receives the input image frame 140 and performs the one or more operations to generate the latent image frames 142. In some examples, the media generator 420 includes a variational autoencoder (VAE) and the VAE includes the encoder 430, the denoiser 122, and the decoder 432.

The denoiser 122 receives the latent image frames 142 and performs multiple sampling operations, as described at least with reference to FIGS. 1-3. The denoiser 122 outputs, in the latent space, the output latent image frames 156 based on the latent image frames 142.

The decoder 432 receives the output latent image frame 156. Additionally, the decoder 432 decodes the output latent image frame 156 to generate the output image frames 160.

In some examples, the device 402 corresponds to or is included in one of various types of devices, such that the processor 108 can be integrated in multiple types of devices. In an illustrative example, the processor 108 of the device 402 is integrated in a mobile device (e.g., a mobile phone or tablet) as depicted in FIG. 6, a wearable electronic device as depicted in FIG. 7, a voice-controlled speaker system as depicted in FIG. 8, a camera as depicted in FIG. 9, a virtual reality, mixed reality, or augmented reality headset as depicted in FIG. 10, a mixed reality or augmented reality glasses device, as described with reference to FIG. 11, a vehicle as depicted in FIG. 12, or a vehicle as depicted in FIG. 13.

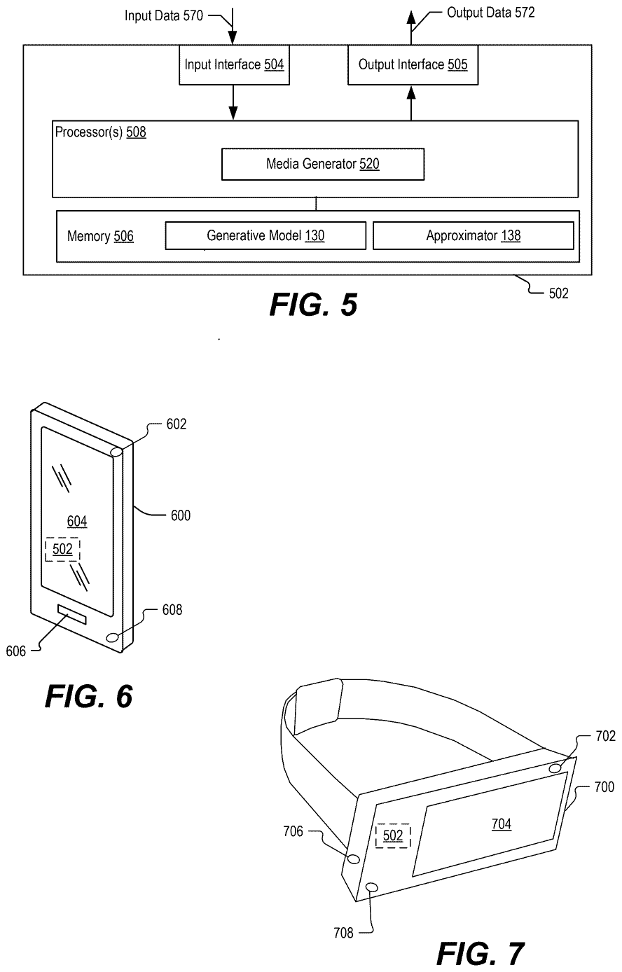

FIG. 5 depicts a diagram of an example of an integrated circuit 502 operable to generate media data, in accordance with some aspects of the present disclosure. For example, the media data may include or correspond to the output latent image frames 156 or the output image frames 160.

The integrated circuit 502 includes one or more processors 508 (herein after referred to as the “processor 508”) and a memory 506. The processor 508 and the memory 506 may include or correspond to the processor 108 and the memory 106, respectively. The processor 508 may include a media generator 520. The media generator 520 may include or correspond to the media generator 120 or 420. The memory 506 includes (e.g., stores) the generative model 130 and the approximator 138. Although the memory 506 includes both the generative model 130 and the approximator 138 in the embodiment shown, in other embodiments the memory 506 may not include the generative model 130, the approximator 138, or a combination thereof. Additionally, or alternatively, the memory 506 may include one or more other models, the scheme 139, the input image frame 140, one or more latent image frames, the output image frames 160, or a combination thereof. In some embodiments, the integrated circuit 502 may not include the memory 506.

The integrated circuit 502 also includes an input interface 504, such as one or more bus interfaces, to enable the integrated circuit 502 to receive signals representing input data 570 for processing. For example, the input data 570 can correspond to or include the instructions 109, the generative model 130, the approximator 138, the scheme 139, the input image frame 140, the input data 415, a weight value (e.g., a value of α), or a combination thereof.

The integrated circuit 502 also includes an output interface 505, such as a bus interface, to enable the integrated circuit 502 to output signals representing output data 572. For example, the output data 572 can correspond to or include the output latent image frames 156, the output image frames 160, audio data, or a combination thereof.

The integrated circuit 502 includes the media generator 520 and, optionally, the generative model 130 and/or the approximator 138. The integrated circuit 502 enables implementation of media data (e.g., the output image frames 160) generation in a system or a device. For example, the system or the device may include a mobile device (e.g., a mobile phone or tablet) as depicted in FIG. 6, a wearable electronic device as depicted in FIG. 7, a voice-controlled speaker system as depicted in FIG. 8, a camera as depicted in FIG. 9, a virtual reality, mixed reality, or augmented reality headset as depicted in FIG. 10, a mixed reality or augmented reality glasses device, as described with reference to FIG. 11, a vehicle as depicted in FIG. 12, or a vehicle as depicted in FIG. 13.

In some embodiments, the system or the device that includes the integrated circuit 502 also includes or is coupled to an image sensor (e.g., a camera), an input device (e.g., a microphone, a keyboard or touch screen, etc.), a display device, a speaker, a modem, or a combination thereof. For example, the image sensor, the input device, the display device, the speaker, and the modem may include or correspond to the image sensor 404, the input device 414, the display device 419, the speaker 421, and the modem 418, respectively.

In some embodiments, the system or the device that includes the integrated circuit 502 is operable to generate media data, such as video data, based on the generative model 130 and/or the approximator 138. For example, the processor 508 (e.g., the media generator 520) is configured to perform multiple sampling operations (e.g., multiple sampling steps) based on an input image frame, such as the input image frame 140. The media generator 520 (including a denoiser) performs a first sampling operation (of the multiple sampling operations) based on the generative model 130. Additionally, the media generator 720 (e.g., the denoiser) also performs a second sampling operation (of the multiple sampling operations) based on the generative model 130 and the approximator 138. The processor 508 (e.g., the media generator 520) is configured to output one or more output image frames (e.g., the output image frames 160), such as a series of image frames of video content, based on the multiple sampling operations.

FIGS. 6-13 depict examples of devices operable to generate media data, in accordance with some aspects of the present disclosure. FIG. 6 depicts a diagram of a mobile device 600 operable to generate media data, in accordance with some aspects of the present disclosure. The mobile device 600 may include or correspond to a phone or a tablet, as illustrative, non-limiting examples. The mobile device 600 includes a camera 602 (e.g., an image sensor), a display 604 (e.g., a display screen), a microphone 606, a speaker 608, and the integrated circuit 502. Components of the integrated circuit 502, including the media generator 520 and, optionally, the generative model 130, the approximator 138, or a combination thereof, are integrated in the mobile device 600 and are illustrated using dashed lines to indicate internal components that are not generally visible to a user of the mobile device 600.

FIG. 7 depicts a diagram of a wearable electronic device 700 operable to generate media data, in accordance with some aspects of the present disclosure. The wearable electronic device 700 may include or correspond to a “smart watch,” as an illustrative, non-limiting example. The wearable electronic device 700 includes a camera 702 (e.g., an image sensor), a display 704 (e.g., a display screen), a microphone 706, a speaker 708, and the integrated circuit 502. Components of the integrated circuit 502, including the media generator 520 and, optionally, the generative model 130, the approximator 138, or a combination thereof, is integrated in the wearable electronic device 700 and are illustrated using dashed lines to indicate internal components that are not generally visible to a user of the wearable electronic device 700.

FIG. 8 is a diagram of a voice-controlled speaker system 800 operable to generate media data, in accordance with some aspects of the present disclosure. The voice-controlled speaker system 800 may include or correspond to a wireless speaker and voice activated device, as an illustrative, non-limiting example. The voice-controlled speaker system 800 can have wireless network connectivity and is configured to execute an assistant operation. The voice-controlled speaker system 800 includes a camera 802 (e.g., an image sensor), a display 804 (e.g., a display screen), a microphone 806, a speaker 808, and the integrated circuit 502. Components of the integrated circuit 502, including the media generator 520 and, optionally, the generative model 130, the approximator 138, or a combination thereof, are integrated in the voice-controlled speaker system 800 and are illustrated using dashed lines to indicate internal components that are not generally visible to a user of the voice-controlled speaker system 800.

FIG. 9 is a diagram of a camera device 900 operable to generate media data, in accordance with some aspects of the present disclosure. The camera device 900 includes an image sensor 902, a display 904 (e.g., a display screen), a microphone 906, a speaker 908, and the integrated circuit 502. Components of the integrated circuit 502, including the media generator 520 and, optionally, the generative model 130, the approximator 138, or a combination thereof, are integrated in the camera device 900 and are illustrated using dashed lines to indicate internal components that are not generally visible to a user of the camera device 900.

FIG. 10 is a diagram of a headset 1000, such as a virtual reality, mixed reality, or augmented reality headset, operable to generate media data, in accordance with some aspects of the present disclosure. A visual interface device is positioned in front of the user's eyes to enable display of augmented reality, mixed reality, or virtual reality images or scenes to the user while the headset 1000 is worn. The headset 1000 also includes a camera 1002 (e.g., an image sensor), a display 1004 (e.g., a display screen), a microphone 1006, a speaker 1008, and the integrated circuit 502. Components of the integrated circuit 502, including the media generator 520 and, optionally, the generative model 130, the approximator 138, or a combination thereof, are integrated in the headset 1000 and are illustrated using dashed lines to indicate internal components that are not generally visible to a user of the headset 1000.

FIG. 11 is a diagram of a mixed reality or augmented reality glasses device 1100 operable to generate media data, in accordance with some aspects of the present disclosure. The glasses 1100 include a holographic projection unit 1104 (e.g., a display system) configured to project visual data onto a surface of a lens 1105 or to reflect the visual data off of a surface of the lens 1105 and onto the wearer's retina. The glasses 1100 also include a camera 1102 (e.g., an image sensor), a microphone 1106, a speaker 1108, and the integrated circuit 502. Components of the integrated circuit 502, including the media generator 520 and, optionally, the generative model 130, the approximator 138, or a combination thereof, are integrated in the glasses 1100 and are illustrated using dashed lines to indicate internal components that are not generally visible to a user of the glasses 1100.

FIG. 12 is a diagram of a first example of a vehicle 1200 operable to generate media data, in accordance with some examples of the present disclosure. The vehicle 1200 may include or correspond to a manned or unmanned aerial device (e.g., a package delivery drone). The vehicle 1200 includes a camera 1202 (e.g., an image sensor), a display 1204 (e.g., a display screen), a microphone 1206, a speaker 1208, and the integrated circuit 502. Components of the integrated circuit 502, including the media generator 520 and, optionally, the generative model 130, the approximator 138, or a combination thereof, are integrated in the vehicle 1200 and are illustrated using dashed lines to indicate internal components that are not generally visible to a user of the vehicle 1200.

FIG. 13 is a diagram of a second example of a vehicle 1300 operable to generate media data, in accordance with some aspects of the present disclosure. The vehicle 1300 may include or correspond to a land craft (e.g., a car), a watercraft, or an aircraft (e.g., an aerial device). In some embodiments, the vehicle 1300 includes or corresponds to a manned or unmanned device (e.g., a package delivery drone) configured to generate media data. The vehicle 1300 includes a camera 1302 (e.g., an image sensor), a display 1304 (e.g., a display screen), a microphone 1306, one or more speakers 1308, and the integrated circuit 502. Components of the integrated circuit 502, including the media generator 520 and, optionally, the generative model 130, the approximator 138, or a combination thereof, are integrated in the vehicle 1300 and are illustrated using dashed lines to indicate internal components that are not generally visible to a user of the vehicle 1300.

In a particular example of one or more of the devices of FIGS. 6-13, the integrated circuit 502 (e.g., the media generator 520) is operable to generate media data (e.g., the output image frames 160) based on the generative model 130 and the approximator 138. For example, based on a request to generate media content, the integrated circuit 502 (e.g., the media generator 520) may perform multiple sampling operations in which at least one sampling operation is performed based on the generative model 130 and at least one other sampling operation is performed based on the generative model 130 and the approximator 138. In some embodiments, the generated media output may be stored at a memory of the integrated circuit 502, sent to another device via a modem coupled to the integrated circuit 502, output via a display or speaker of the one or more devices of FIG. 4 or 6-13, or a combination thereof. One technical advantage of the integrated circuit 502 (e.g., the media generator 520) implemented by the one or more devices of FIGS. 6-13 as described above is that a sampling operation performed using the approximator 138 can be performed faster and conserve power as compared to a sampling operation performed using the generative model 130. Additionally, the techniques described herein can perform the multiple sampling operations using the generative model 130 and the approximator 138 to generate video data that would otherwise take longer and be more computationally expensive as compared to conventional techniques which use the same generative model for each sampling operation of the multiple sampling operations. For example, as compared to the conventional techniques, the techniques described herein can reduce a cost (e.g., an amount of time and/or power consumption) of video generation with little to no loss in temporal consistency and video quality.

The embodiments of the systems or devices as described with reference to FIGS. 6-13 are described, respectively, as including a display, a microphone, a speaker, a camera, or a combination thereof. As described with reference to FIGS. 6-13, the display, the microphone, the speaker, the camera may include or correspond to the display device 419, the input device 414, the speaker 421, and the image sensor 404, respectively. It is noted that in other embodiments of the systems or devices of FIGS. 6-13, one or more of the systems or devices of FIGS. 6-13, respectively, may not include the display, the microphone, the speaker, the camera, or a combination thereof. Additionally, or alternatively, one or more of the systems or devices of FIGS. 6-13 may include an additional component. For example, the additional component may include a modem, such as the modem 418. Although the systems or devices of FIGS. 6-13 are each described as including the integrated circuit 502, in other embodiments, one or more of the systems or devices of FIGS. 6-13 can alternatively include the memory 506, the processor 508, or both, without including the other aspects of the integrated circuit 502.

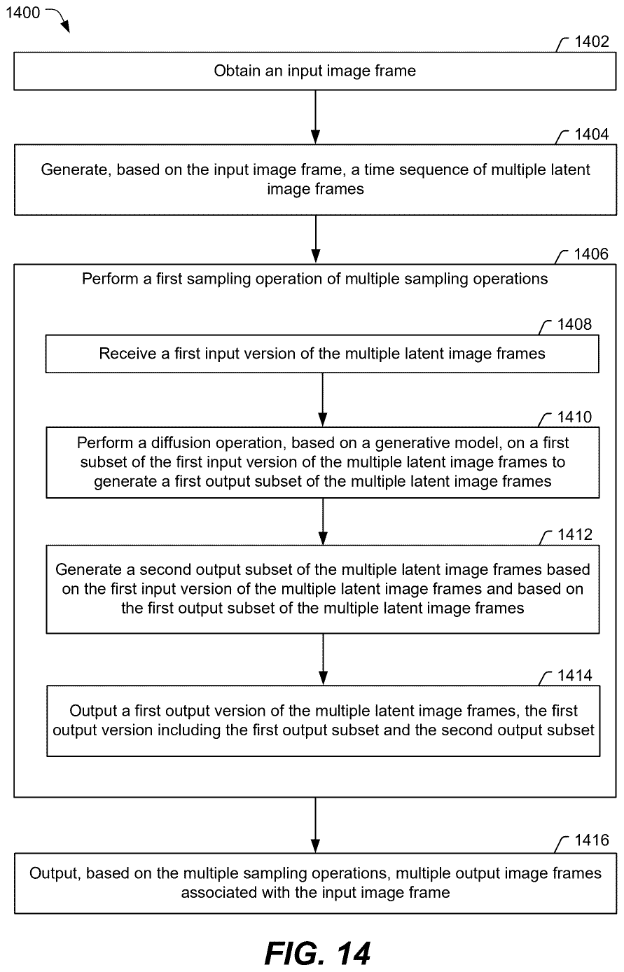

FIG. 14 is a diagram of an example of a method 1400 of generating media data, in accordance with some aspects of the present disclosure. For example, the media data may include or correspond to the output image frames 160. In a particular aspect, one or more operations of the method 1400 are performed by the system 100, the device 102 (e.g., a media device), the processor 108, the media generator 120, the denoiser 122, the system 400, the device 402, the media generator 420, the integrated circuit 502, the processor 508, the media generator 520, one or more of the devices of FIGS. 6-13, or a combination thereof.

In some embodiments, the method 1400 includes, at block 1402, obtaining an input image frame. For example, the input image frame may include or correspond to the input image frame 140.

At block 1404, the method 1400 includes generating, based on the input image frame, a time sequence of multiple latent image frames. For example, the multiple latent image frames may include or correspond to the latent image frames 142, the input version 144, the latent image frames 210, 211, 212, or 213, the latent image frames 301-311, or a combination thereof. In some implementations, the time sequence of the multiple latent image frames may be generated by the media generator 120 or 420, or the encoder 430.

At block 1406, the method 1400 includes performing a first sampling operation of multiple sampling operations. The multiple sampling operations may include or correspond to the sampling operations 202, 204, and 206 or the sampling operations 331-355. In some embodiment, the multiple sampling operations may be performed by the denoiser 122, such as described at least with reference to FIGS. 1-3. The first sampling operation may include or correspond to the second sampling operation 204 of the multiple sampling operations 202-206, as an illustrative, non-limiting example. In some implementations, performing the first sampling operation at block 1406 includes additional blocks, such as blocks 1408-1414 as described further herein.

At block 1408, the method 1400 includes receiving a first input version of the multiple latent image frames. The first input version includes or corresponds to the latent image frames 142 or the input version 144.

At block 1410, the method 1400 includes performing a diffusion operation, based on a generative model, on a first subset of the first input version of the multiple latent image frames to generate a first output subset of the multiple latent image frames. The generative model and the first subset may include or correspond to the generative model 130 and the first subset 146. Additionally, the first output subset may include or correspond to the first output subset 152.

The generative model may include an image-to-video generative model. In some implementations, the generative model has a U-Net architecture. Additionally, or alternatively, the generative model is applied to perform a text-based video generation operation, a text-based video content editing operation, image-based video generation operation, a video enhancement operation, video compression, a data augmentation operation, or a combination thereof.

At block 1412, the method 1400 includes generating a second output subset of the multiple latent image frames based on the first input version of the multiple latent image frames and based on the first output subset of the multiple latent image frames. The second output subset may include or correspond to the second output subset 154. In some implementations, the second output subset 154 may be generated by the processor 108, the media generator 120, the denoiser 122, the approximator 138 or the media generator 420.

In some embodiments, generating the second output subset of the multiple latent image frames, at block 1412, includes interpolating the second output subset based on the first input version and the first output subset. Interpolating the second output subset may include performing a linear interpolation operation. Additionally, or alternatively, in some examples, interpolating the second output subset may include determining a change value based on the first subset and the first output subset, determining a weight value, and modifying the change value based on the weight value. In some such examples, interpolating the second output subset may further include generating the second output subset based on the modified change value and a second subset of the first input version of the multiple latent image frames. The second subset of the first input version may include or correspond to the second subset 148.

At block 1414, the method 1400 includes outputting a first output version of the multiple latent image frames. The first output version may include or correspond to the output version 150. The first output version includes the first output subset and the second output subset. To illustrate, the output version 150 of FIG. 1 includes the first output subset 152 and the second output subset 154. The first output version may be output by the denoiser 122, the media generator 120 or 420, or the processor 108.

At block 1416, the method 1400 includes outputting, based on the multiple sampling operations, multiple output image frames associated with the input image frame. For example, the multiple output image frames may include or correspond to the output image frames 160. The multiple output image frames can include a time sequence of the multiple output image frames. In some embodiments, the multiple output image frames include fourteen or more image frames associated with the input image frame. For example, the multiple output image frames may include twenty-five image frames.

In some embodiments, the method 1400 includes performing the multiple sampling operations. The multiple sampling operations may include two or more sampling operations. For example, the multiple sampling operations (e.g., multiple sampling steps) may include the first sampling operation and a second sampling operation, and optionally a third sampling operation. Each sampling operation of the multiple sampling operations may be performed based on or in association with the input image frame.

In some embodiments, the method 1400 includes performing a second sampling operation of the multiple sampling operations. To perform the second sampling operation, the method 1400 may include receiving a second input version of the multiple latent image frames, and performing the diffusion operation, based on the generative model, on the second input version of the multiple latent image frames to generate a second output version of the multiple latent image frames. The diffusion operation may be performed based on or using the generative model 130. In some implementations, performing the second sampling operation can also include outputting the second output version of the multiple latent image frames. Additionally, or alternatively, a first power consumption associated with performance of the first sampling operation is less than a second power consumption associated with performance of the second sampling operation.

The second sampling operation can be performed prior to or after the first sampling operation. In implementations where the second sampling operation is performed prior to the first sampling operation, the second output version is provided as the first input version for the second sampling operation. In implementations where the second sampling operation is performed after the first sampling operation, the first output version is provided as the second input version for the second sampling operation.

In some embodiments, the method 1400 includes performing a third sampling operation of the multiple sampling operations. The third sampling operation may be performed prior to or after the second sampling operation. To perform the third sampling operation, the method 1400 may include receiving the second output version of the multiple latent image frames as a third input version of the multiple latent image frames, and performing the diffusion operation, based on the generative model, on a first subset of the third input version of the multiple latent image frames to generate a third output subset of the multiple latent image frames. In some implementations, the multiple latent image frames include a subset of latent image frames, and each of the first subset of the first input version and the first subset of the third input version are associated with the subset of latent image frames of the multiple latent image frames. Performing the third sampling operation can also include generating a fourth output subset of the multiple latent image frames based on the third input version of the multiple latent image frames and based on the third output subset of the multiple latent image frames. In some implementations, performing the second sampling operation can also include outputting a third output version of the multiple latent image frames. The third output version may include the third output subset and the fourth output subset.

In some embodiments, the method 1400 includes encoding, via or by a VAE, the input image frame to generate a latent representation of the input image frame. For example, the encoder and the latent representation may include or correspond to the encoder 430 and at least one of the latent image frames 142, respectively. Additionally, or alternatively, the method 1400 includes decoding a final version of the multiple latent image frames based on the multiple sampling operations to generate the multiple output image frames. For example, the decoder 432 may decode the final version to generate the output image frames 160.

In some embodiments, the method 1400 includes transmitting, via or by a modem, the multiple output image frames to a second device for output by the second device. For example, the modem may include or correspond to the modem 418. In some embodiments, the method 1400 includes receiving, from a microphone, an input signal that includes a request to generate the multiple output image frames. For example, the microphone may include or correspond to the input device 414 or a microphone of one or more of the devices of FIGS. 6-13. Additionally, or alternatively, the method 1400 includes outputting, via or by a speaker, audio associated with the multiple output image frames. The speaker may include or correspond to the speaker 421 or a speaker of one or more of the devices of FIGS. 6-13.

In some embodiments, the method 1400 includes generating, via or by one or more cameras, image data associated with the input image frame. For example, the one or more cameras may include or correspond to the image sensor 404 or a camera of one or more of the devices of FIGS. 6-13. In some such embodiments, the multiple output image frames are generated at least partially based on the image data from the one or more cameras. Additionally, or alternatively, the method 1400 may include receiving an input that includes a request to generate video data including the multiple output image frames based on image data, such as the image data from the one or more cameras. For example, the input may include or correspond to the input data 415 or 570. The method 1400 may also include outputting, via, or by a display device, the multiple output image frames as video content. For example, the display device may include or correspond to the display device 419 or a display of one or more of the devices of FIGS. 6-13.

In some embodiments, the method 1400 includes performing a speech to text conversion operation on an input, obtained from a microphone, to generate text data. In some such embodiments, the generative model is applied, based on the text data, to perform a text-based video generation operation or a text-based video content editing operation

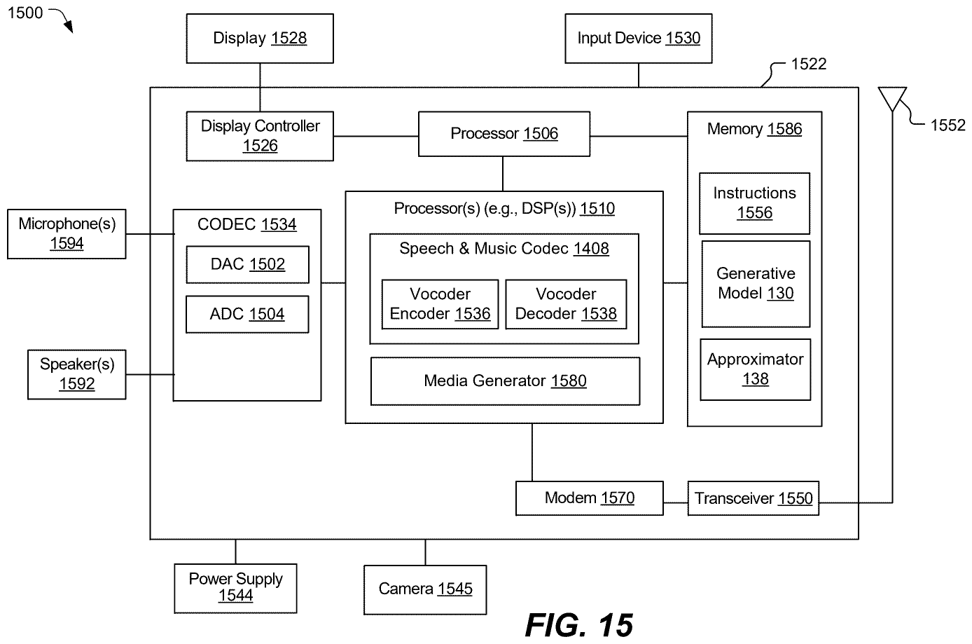

The method 1400 of FIG. 14 may be implemented by a field-programmable gate array (FPGA) device, an application-specific integrated circuit (ASIC), a processing unit such as a central processing unit (CPU), a DSP, a controller, another hardware device, firmware device, or any combination thereof. As an example, the method 1400 of FIG. 14 may be performed by a processor that executes instructions, such as described with reference to FIG. 15.

It is noted that one or more blocks (or operations) described with reference to FIG. 14 may be combined with one or more blocks (or operations) described with reference to another of the figures. For example, one or more blocks (or operations) of FIG. 14 may be combined with one or more blocks (or operations) associated with FIGS. 1-13. Additionally, or alternatively, one or more operations described above with reference to FIGS. 1-14 may be combined with one or more operations described with reference to FIG. 15.

FIG. 15 is a block diagram of an illustrative example of a device 1500 that is operable to generate media data, in accordance with one or more aspects of the present disclosure. In various implementations, the device 1500 may have more or fewer components than illustrated in FIG. 15. In an illustrative implementation, the device 1500 may correspond to the device 102 or 402, or to any of the devices of FIGS. 6-13. In an illustrative implementation, the device 1500 may perform one or more operations described with reference to FIGS. 1-14.

In a particular implementation, the device 1500 includes a processor 1506 (e.g., a central processing unit (CPU)). The device 1500 may include one or more additional processors 1510 (e.g., one or more DSPs). In a particular aspect, the processor 108 or 508 corresponds to the processor 1506, the processors 1510, or a combination thereof. The processors 1510 may include a speech and music coder-decoder (CODEC) 1508 that includes a voice coder (“vocoder”) encoder 1536, a vocoder decoder 1538, or a combination thereof. Additionally, or alternatively, the processors 1510 may include a media generator 1580. The media generator 1580 may include or correspond to the media generator 120, 420, or 520. In some examples, the processor 1506 or 1510 is configured to use or apply the generative model, the approximator 138, or a combination thereof.

In this context, the term “processor” refers to an integrated circuit consisting of logic cells, interconnects, input/output blocks, clock management components, memory, and optionally other special purpose hardware components, designed to execute instructions and perform various computational tasks. Examples of processors include, without limitation, central processing units (CPUs), digital signal processors (DSPs), neural processing units (NPU), graphics processing units (GPUs), field programmable gate arrays (FPGAs), microcontrollers, quantum processors, coprocessors, vector processors, other similar circuits, and variants and combinations thereof. In some cases, a processor can be integrated with other components, such as communication components, input/output components, etc. to form a system on a chip (SOC) device or a packaged electronic device.

Taking CPUs as a starting point, a CPU typically includes one or more processor cores, each of which includes a complex, interconnected network of transistors and other circuit components defining logic gates, memory elements, etc. A core is responsible for executing instructions to, for example, perform arithmetic and logical operations. Typically, a CPU includes an Arithmetic Logic Unit (ALU) that handles mathematical operations and a Control Unit that generates signals to coordinate the operation of other CPU components, such as to manage operations a fetch-decode-execute cycle.

CPUs and/or individual processor cores generally include local memory circuits, such as registers and cache to temporarily store data during operations. Registers include high-speed, small-sized memory units intimately connected to the logic cells of a CPU. Often registers include transistors arranged as groups of flip-flops, which are configured to store binary data. Caches include fast, on-chip memory circuits used to store frequently accessed data. Caches can be implemented, for example, using Static Random-Access Memory (SRAM) circuits.

Operations of a CPU (e.g., arithmetic operations, logic operations, and flow control operations) are directed by software and firmware. At the lowest level, the CPU includes an instruction set architecture (ISA) that specifies how individual operations are performed using hardware resources (e.g., registers, arithmetic units, etc.). Higher level software and firmware is translated into various combinations of ISA operations to cause the CPU to perform specific higher-level operations. For example, an ISA typically specifies how the hardware components of the CPU move and modify data to perform operations such as addition, multiplication, and subtraction, and high-level software is translated into sets of such operations to accomplish larger tasks, such as adding two columns in a spreadsheet. Generally, a CPU operates on various levels of software, including a kernel, an operating system, applications, and so forth, with each higher level of software generally being more abstracted from the ISA and usually more readily understandable by human users.

GPUs, NPUs, DSPs, microcontrollers, coprocessors, FPGAs, ASICS, and vector processors include components similar to those described above for CPUs. The differences among these various types of processors are generally related to the use of specialized interconnection schemes and ISAs to improve a processor's ability to perform particular types of operations. For example, the logic gates, local memory circuits, and the interconnects therebetween of a graphics processing unit (GPU) are specifically designed to improve parallel processing, sharing of data between processor cores, and vector operations, and the ISA of the GPU may define operations that take advantage of these structures. As another example, ASICs are highly specialized processors that include similar circuitry arranged and interconnected for a particular task, such as encryption or signal processing. As yet another example, FPGAs are programmable devices that include an array of configurable logic blocks (e.g., interconnected sets of transistors and memory elements) that can be configured (often on the fly) to perform customizable logic functions.

The device 1500 may include a memory 1586 and a CODEC 1534. The memory 1586 may include or correspond to the memory 106 or 506. The memory 1586 may include instructions 1556, that are executable by the one or more additional processors 1510 (or the processor 1506) to implement the functionality described with reference to the processor 1506 or 1510, the media generator 1580, or a combination thereof. The instructions 1556 may include or correspond to the instructions 109. The memory 1586 is also configured to store the generative model 130 and the approximator 138. Additionally, or alternatively, the memory 1586 may also include the scheme 139. The device 1500 may include the modem 1570 coupled, via a transceiver 1550, to an antenna 1552. The modem 1570 may include or correspond to the modem 418.

The device 1500 may include a display 1528 coupled to a display controller 1526. The display 1528 may include or correspond to the display device 419 or a display of one of the devices of FIGS. 6-13. One or more speakers 1592, the microphone(s) 1594, or a combination thereof, may be coupled to the CODEC 1534. For example, the one or more speakers 1592 may include or correspond to the speaker 421 or a speaker of one or more of the devices of FIGS. 6-13. As another example, the one or more microphones 1594 may include or correspond to the input device 414 or a microphone of one or more of the devices of FIGS. 6-13. The CODEC 1534 may include a digital-to-analog converter (DAC) 1502, an analog-to-digital converter (ADC) 1504, or both. In a particular implementation, the CODEC 1534 may receive analog signals from the microphone(s) 1594, convert the analog signals to digital signals using the analog-to-digital converter 1504, and provide the digital signals to the speech and music codec 1508. In a particular implementation, the speech and music codec 1508 may provide digital signals to the CODEC 1534. The CODEC 1534 may convert the digital signals to analog signals using the digital-to-analog converter 1502 and may provide the analog signals to the speaker 1592.

In a particular implementation, the device 1500 may be included in a system-in-package or system-on-chip device 1522. For example, the system-in-package or system-on-chip device 1522 may include or correspond to the integrated circuit 502. In a particular implementation, the memory 1586, the processor 1506, the processors 1510, the display controller 1526, the CODEC 1534, and the modem 1570 are included in the system-in-package or system-on-chip device 1522. In a particular implementation, an input device 1530, a power supply 1544, and a camera 1545 are coupled to the system-in-package or the system-on-chip device 1522. For example, the input device 1530 may include or correspond to the input device 414, the display device 419, a microphone of one or more of the devices of FIGS. 6-13, or a display of one or more of the devices of FIGS. 6-13. As another example, the camera 1545 may include or correspond to the image sensor 404, the input device 414, or a camera of one or more of the devices of FIGS. 6-13. In some examples, the input device 1530 may include or be associated with the display device 419 or a display device of one or more of the devices of FIGS. 6-13. Moreover, in a particular implementation, as illustrated in FIG. 15, the display 1528, the input device 1530, the speaker(s) 1592, the microphone(s) 1594, the antenna 1552, the power supply 1544, and the camera 1545 are external to the system-in-package or the system-on-chip device 1522. In a particular implementation, each of the display 1528, the input device 1530, the speaker(s) 1592, the microphone(s) 1594, the antenna 1552, the power supply 1544, and the camera 1545 may be coupled to a component of the system-in-package or the system-on-chip device 1522, such as an interface or a controller.

The device 1500 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a car, a computing device, a communication device, an internet-of-things (IoT) device, a virtual reality (VR) device, a base station, a mobile device, or any combination thereof.

In conjunction with the described implementations, an apparatus includes means for obtaining an input image frame. For example, the means for obtaining can include the system 100, the device 102, the memory 106, the processor 108, the media generator 120, the denoiser 122, the system 400, the device 402, the image sensor 404, the input device 414, the modem 418, the media generator 420, the encoder 430, the integrated circuit 502, the input interface 504, the processor 508, the memory 506, the mobile device 600, the camera 602, the wearable electronic device 700, the camera 702, the voice-controlled speaker system 800, the camera 802, the camera device 900, the image sensor 902, the headset 1000, the camera 1002, the glasses 1100, the camera 1102, the vehicle 1200, the camera 1202, the vehicle 1300, the camera 1302, the device 1500, the processor 1506, the processor(s) 1510, the system-in-package or the system-on-chip device 1522, the input device 1530, the camera 1545, the modem 1570, the media generator 1580, other circuitry configured to obtain an input image frame, or a combination thereof.

The apparatus also includes means for generating, based on the input image frame, a time sequence of multiple latent image frames. For example, the means for generating the time sequence of the multiple latent image frames can include the system 100, the device 102, the processor 108, the media generator 120, the system 400, the device 402, the media generator 420, the encoder 430, the integrated circuit 502, the processor 508, the media generator 520, the mobile device 600, the wearable electronic device 700, the voice-controlled speaker system 800, the camera device 900, the headset 1000, the glasses 1100, the vehicle 1200, the vehicle 1300, the device 1500, the processor 1506, the processor(s) 1510, the system-in-package or the system-on-chip device 1522, the media generator 1580, other circuitry configured to generate a time sequence of multiple latent image frames, or a combination thereof.

The apparatus further includes means for performing a first sampling operation of multiple sampling operations. For example, the means for performing the first sampling operation can include the system 100, the device 102, the processor 108, the media generator 120, the denoiser 122, the generative model 130, the approximator 138, the system 400, the device 402, the media generator 420, the integrated circuit 502, the processor 508, the media generator 520, the mobile device 600, the wearable electronic device 700, the voice-controlled speaker system 800, the camera device 900, the headset 1000, the glasses 1100, the vehicle 1200, the vehicle 1300, the device 1500, the processor 1506, the processor(s) 1510, the system-in-package or the system-on-chip device 1522, the media generator 1580, other circuitry configured to perform a first sampling operation, or a combination thereof.

The means for performing the first sampling operation can include means for receiving a first input version of the multiple latent image frames. For example, the means for receiving the first input version can include the system 100, the device 102, the processor 108, the media generator 120, the denoiser 122, the generative model 130, the approximator 138, the system 400, the device 402, the media generator 420, the integrated circuit 502, the processor 508, the media generator 520, the mobile device 600, the wearable electronic device 700, the voice-controlled speaker system 800, the camera device 900, the headset 1000, the glasses 1100, the vehicle 1200, the vehicle 1300, the device 1500, the processor 1506, the processor(s) 1510, the system-in-package or the system-on-chip device 1522, the media generator 1580, other circuitry configured to generate a time sequence of multiple latent image frames, or a combination thereof.

The means for performing the first sampling operation can include means for performing a diffusion operation, based on a generative model, on a first subset of the first input version of the multiple latent image frames to generate a first output subset of the multiple latent image frames. For example, the means for performing the diffusion operation can include the system 100, the device 102, the processor 108, the media generator 120, the denoiser 122, the generative model 130, the system 400, the device 402, the media generator 420, the integrated circuit 502, the processor 508, the media generator 520, the mobile device 600, the wearable electronic device 700, the voice-controlled speaker system 800, the camera device 900, the headset 1000, the glasses 1100, the vehicle 1200, the vehicle 1300, the device 1500, the processor 1506, the processor(s) 1510, the system-in-package or the system-on-chip device 1522, the media generator 1580, other circuitry configured to generate a time sequence of multiple latent image frames, or a combination thereof.

The means for performing the first sampling operation can include means for generating a second output subset of the multiple latent image frames based on the first input version of the multiple latent image frames and based on the first output subset of the multiple latent image frames. For example, the means for generating the second output subset of the multiple latent image frames can include the system 100, the device 102, the processor 108, the media generator 120, the denoiser 122, the approximator 138, the system 400, the device 402, the media generator 420, the integrated circuit 502, the processor 508, the media generator 520, the mobile device 600, the wearable electronic device 700, the voice-controlled speaker system 800, the camera device 900, the headset 1000, the glasses 1100, the vehicle 1200, the vehicle 1300, the device 1500, the processor 1506, the processor(s) 1510, the system-in-package or the system-on-chip device 1522, the media generator 1580, other circuitry configured to generate a time sequence of multiple latent image frames, or a combination thereof.

The means for performing the first sampling operation can include means for outputting a first output version of the multiple latent image frames. For example, the means for outputting the first output version of the multiple latent image frames can the system 100, the device 102, the processor 108, the media generator 120, the denoiser 122, the generative model 130, the approximator 138, the system 400, the device 402, the media generator 420, the integrated circuit 502, the processor 508, the media generator 520, the mobile device 600, the wearable electronic device 700, the voice-controlled speaker system 800, the camera device 900, the headset 1000, the glasses 1100, the vehicle 1200, the vehicle 1300, the device 1500, the processor 1506, the processor(s) 1510, the system-in-package or the system-on-chip device 1522, the media generator 1580, other circuitry configured to generate a time sequence of multiple latent image frames, or a combination thereof. The first output version includes the first output subset and the second output subset.

The apparatus includes means for outputting, based on the multiple sampling operations, multiple output image frames associated with the input image frame. For example, the means for outputting the multiple output image frames can include the system 100, the device 102, the memory 106, the processor 108, the media generator 120, the denoiser 122, the system 400, the device 402, the modem 418, the display device 419, the media generator 420, the decoder 432, the integrated circuit 502, the output interface 505, the processor 508, the mobile device 600, the display 604, the wearable electronic device 700, the display 704, the voice-controlled speaker system 800, the display 804, the camera device 900, the display 904, the headset 1000, the display 1004, the glasses 1100, the holographic projection unit 1104 (e.g., a display system), the vehicle 1200, the display 1204, the vehicle 1300, the display 1304, the device 1500, the processor 1506, the processor(s) 1510, the system-in-package or the system-on-chip device 1522, the display controller 1526, the display 1528, the modem 1570, the media generator 1580, the memory 1586, other circuitry configured to output the multiple output image frames, or a combination thereof.

In some implementations, a non-transitory computer-readable medium (e.g., a computer-readable storage device, such as the memory 1586) includes instructions (e.g., the instructions 1556) that, when executed by one or more processors (e.g., the one or more processors 1510 or the processor 1506), cause the one or more processors to obtain an input image frame (e.g., the input image frame 140), and generate, based on the input image frame, a time sequence of multiple latent image frames (e.g., the latent image frames 142 or the latent image frames 301-311). The instructions further cause the one or more processors to, for a first sampling operation (e.g., the second sampling operation 204) of multiple sampling operations, receive a first input version (e.g., the input version 144) of the multiple latent image frames, and perform a diffusion operation, based on a generative model (e.g., the generative model 130), on a first subset (e.g., the first subset 146) of the first input version of the multiple latent image frames to generate a first output subset (e.g., the first output subset 152) of the multiple latent image frames. The instructions further cause the one or more processors to, for the first sampling operation, generate a second output subset (e.g., the second output subset 154) of the multiple latent image frames based on the first input version of the multiple latent image frames and based on the first output subset of the multiple latent image frames, and output a first output version (e.g., the output version 150 or the output latent image frames 156) of the multiple latent image frames. The first output version includes the first output subset and the second output subset. The instructions also cause the one or more processors to output, based on the multiple sampling operations, multiple output image frames (e.g., the output image frames 160) associated with the input image frame.

Particular aspects of the disclosure are described below in sets of interrelated Examples:

According to Example 1, a device includes a memory configured to store a generative model; and one or more processors configured to obtain an input image frame; generate, based on the input image frame, a time sequence of multiple latent image frames; for a first sampling operation of multiple sampling operations: receive a first input version of the multiple latent image frames; perform a diffusion operation, based on the generative model, on a first subset of the first input version of the multiple latent image frames to generate a first output subset of the multiple latent image frames; generate a second output subset of the multiple latent image frames based on the first input version of the multiple latent image frames and based on the first output subset of the multiple latent image frames; and output a first output version of the multiple latent image frames, the first output version including the first output subset and the second output subset; and output, based on the multiple sampling operations, multiple output image frames associated with the input image frame.

Example 2 includes the device of Example 1, where the generative model includes an image-to-video generative model; the generative model has a U-Net architecture; the multiple output image frames is a time sequence of the multiple output image frames; or a combination thereof.

Example 3 includes the device of Example 1 or Example 2, where, to generate the second output subset of the multiple latent image frames, the one or more processors are configured to interpolate the second output subset based on the first input version and the first output subset.

Example 4 includes the device of Example 3, where, to interpolate the second output subset, the one or more processors are configured to determine a change value based on the first subset and the first output subset; determine a weight value; modify the change value based on the weight value; and generate the second output subset based on the modified change value and a second subset of the first input version of the multiple latent image frames.

Example 5 includes the device of Example 3, where, to interpolate the second output subset, the one or more processors are configured to perform a linear interpolation operation.

Example 6 includes the device of any of Examples 1-5, where the one or more processors are configured to, for a second sampling operation of the multiple sampling operations: receive a second input version of the multiple latent image frames; perform the diffusion operation, based on the generative model, on the second input version of the multiple latent image frames to generate a second output version of the multiple latent image frames; and output the second output version of the multiple latent image frames.

Example 7 includes the device of Example 6, where a first power consumption associated with performance of the first sampling operation is less than a second power consumption associated with performance of the second sampling operation.

Example 8 includes the device of Example 6 or Example 7, where the second sampling operation is performed prior to the first sampling operation; and the second output version is provided as the first input version for the second sampling operation.

Example 9 includes the device of Example 6 or Example 7, where the second sampling operation is performed after the first sampling operation; and the first output version is provided as the second input version for the second sampling operation.

Example 10 includes the device of Example 9, where the one or more processors are configured to, for a third sampling operation of the multiple sampling operations: receive the second output version of the multiple latent image frames as a third input version of the multiple latent image frames; perform the diffusion operation, based on the generative model, on a first subset of the third input version of the multiple latent image frames to generate a third output subset of the multiple latent image frames; generate a fourth output subset of the multiple latent image frames based on the third input version of the multiple latent image frames and based on the third output subset of the multiple latent image frames; and output a third output version of the multiple latent image frames, the third output version including the third output subset and the fourth output subset.

Example 11 includes the device of Example 10, where the multiple latent image frames include a subset of latent image frames; and each of the first subset of the first input version and the first subset of the third input version are associated with the subset of latent image frames of the multiple latent image frames.

Example 12 includes the device of any of Examples 1-11, where the one or more processors are configured to encode, via a variational autoencoder (VAE), the input image frame to generate a latent representation of the input image frame; and decode a final version of the multiple latent image frames based on the multiple sampling operations to generate the multiple output image frames; and where the multiple output image frames include fourteen or more image frames associated with the input image frame.

Example 13 includes the device of any of Examples 1-12, where the generative model is applied to perform a text-based video generation operation, a text-based video content editing operation, image-based video generation operation, a video enhancement operation, video compression, a data augmentation operation, or a combination thereof.

Example 14 includes the device of any of Examples 1-13, and where the device further includes one or more cameras coupled to the one or more processors and configured to generate image data associated with the input image frame.

Example 15 includes the device of Example 14, where the multiple output image frames are generated by the one or more processors at least partially based on the image data from the one or more cameras.

Example 16 includes the device of Example 14 or Example 15, and where the device further includes an input device configured to receive an input and provide the input to the one or more processors, where the input includes a request to generate video data including the multiple output image frames based on the image data from the one or more cameras.

Example 17 includes the device of any of Examples 1-16, and where the device further includes a display device coupled to the one or more processors and configured to output the multiple output image frames as video content.

Example 18 includes the device of any of Examples 1-17, and where the device further includes a modem coupled to the one or more processors, the modem configured to transmit the multiple output image frames to a second device for output by the second device.

Example 19 includes the device of any of Examples 1-18, and where the device further includes: a microphone configured to provide an input signal to the one or more processors to cause the one or more processors to generate the multiple output image frames; a speaker configured to output audio associated with the multiple output image frames; or a combination thereof.

Example 20 includes the device of any of Examples 1-19, where the one or more processors are integrated in a mobile phone, a tablet computer device, a wearable electronic device, a virtual reality headset, a mixed reality headset, an augmented reality headset, or a camera device.

According to Example 21, a method of operating a media device includes obtaining an input image frame; generating, based on the input image frame, a time sequence of multiple latent image frames; for a first sampling operation of multiple sampling operations: receiving a first input version of the multiple latent image frames; performing a diffusion operation, based on a generative model, on a first subset of the first input version of the multiple latent image frames to generate a first output subset of the multiple latent image frames; generating a second output subset of the multiple latent image frames based on the first input version of the multiple latent image frames and based on the first output subset of the multiple latent image frames; and outputting a first output version of the multiple latent image frames, the first output version including the first output subset and the second output subset; and outputting, based on the multiple sampling operations, multiple output image frames associated with the input image frame.

Example 22 includes the method of Example 21, where the generative model includes an image-to-video generative model; the generative model has a U-Net architecture; the multiple output image frames is a time sequence of the multiple output image frames; or a combination thereof.

Example 23 includes the method of Example 21 or Example 22, where generating the second output subset of the multiple latent image frames includes interpolating the second output subset based on the first input version and the first output subset.

Example 24 includes the method of Example 23, where interpolating the second output subset includes: determining a change value based on the first subset and the first output subset; determining a weight value; modifying the change value based on the weight value; and generating the second output subset based on the modified change value and a second subset of the first input version of the multiple latent image frames.

Example 25 includes the method of Example 23, where interpolating the second output subset includes performing a linear interpolation operation.

Example 26 includes the method of any of Examples 21-25, and where the method further includes, for a second sampling operation of the multiple sampling operations: receiving a second input version of the multiple latent image frames; performing the diffusion operation, based on the generative model, on the second input version of the multiple latent image frames to generate a second output version of the multiple latent image frames; and outputting the second output version of the multiple latent image frames.

Example 27 includes the method of Example 26, where a first power consumption associated with performance of the first sampling operation is less than a second power consumption associated with performance of the second sampling operation.

Example 28 includes the method of Example 26 or Example 27, where the second sampling operation is performed prior to the first sampling operation; and the second output version is provided as the first input version for the second sampling operation.

Example 29 includes the method of Example 26 or Example 27, where the second sampling operation is performed after the first sampling operation; and the first output version is provided as the second input version for the second sampling operation.

Example 30 includes the method of Example 29, and where the method further includes, for a third sampling operation of the multiple sampling operations: receiving the second output version of the multiple latent image frames as a third input version of the multiple latent image frames; performing the diffusion operation, based on the generative model, on a first subset of the third input version of the multiple latent image frames to generate a third output subset of the multiple latent image frames; generating a fourth output subset of the multiple latent image frames based on the third input version of the multiple latent image frames and based on the third output subset of the multiple latent image frames; and outputting a third output version of the multiple latent image frames, the third output version including the third output subset and the fourth output subset.

Example 31 includes the method of Example 30, where the multiple latent image frames include a subset of latent image frames; and each of the first subset of the first input version and the first subset of the third input version are associated with the subset of latent image frames of the multiple latent image frames.

Example 32 includes the method of any of Examples 21-31, and where the method further includes encoding, via a variational autoencoder (VAE), the input image frame to generate a latent representation of the input image frame; and decoding a final version of the multiple latent image frames based on the multiple sampling operations to generate the multiple output image frames; and where the multiple output image frames include fourteen or more image frames associated with the input image frame.

Example 33 includes the method of any of Examples 21-32, where the generative model is applied to perform a text-based video generation operation, a text-based video content editing operation, image-based video generation operation, a video enhancement operation, video compression, a data augmentation operation, or a combination thereof.

Example 34 includes the method of any of Examples 21-33, and where the method further includes generating, by one or more cameras, image data associated with the input image frame.

Example 35 includes the method of Example 34, where the multiple output image frames are generated at least partially based on the image data from the one or more cameras.

Example 36 includes the method of Example 34 or Example 35, and where the method further includes receiving an input that includes a request to generate video data including the multiple output image frames based on the image data from the one or more cameras.

Example 37 includes the method of any of Examples 21-36, and where the method further includes outputting, by a display device, the multiple output image frames as video content.

Example 38 includes the method of any of Examples 21-37, and where the method further includes transmitting, by a modem, the multiple output image frames to a second device for output by the second device.

Example 39 includes the method of any of Examples 21-38, and where the method further includes receiving, from a microphone, an input signal that includes a request to generate the multiple output image frames; outputting, via a speaker, audio associated with the multiple output image frames; or a combination thereof.

Example 40 includes the method of any of Examples 21-39, where the media device includes a mobile phone, a tablet computer device, a wearable electronic device, a virtual reality headset, a mixed reality headset, an augmented reality headset, or a camera device.

According to Example 41, a non-transitory computer-readable medium that stores instructions that are executable by one or more processors to cause the one or more processors to obtain an input image frame; generate, based on the input image frame, a time sequence of multiple latent image frames; for a first sampling operation of multiple sampling operations: receive a first input version of the multiple latent image frames; perform a diffusion operation, based on a generative model, on a first subset of the first input version of the multiple latent image frames to generate a first output subset of the multiple latent image frames; generate a second output subset of the multiple latent image frames based on the first input version of the multiple latent image frames and based on the first output subset of the multiple latent image frames; and output a first output version of the multiple latent image frames, the first output version including the first output subset and the second output subset; and output, based on the multiple sampling operations, multiple output image frames associated with the input image frame.

Example 42 includes the non-transitory computer-readable medium of Example 41, where the generative model includes an image-to-video generative model; the generative model has a U-Net architecture; the multiple output image frames is a time sequence of the multiple output image frames; or a combination thereof.

Example 43 includes the non-transitory computer-readable medium of Example 41 or Example 42, and where, to generate the second output subset of the multiple latent image frames, the instructions are further executable by the one or more processors to cause the one or more processors to interpolate the second output subset based on the first input version and the first output subset.

Example 44 includes the non-transitory computer-readable medium of Example 43, and where, to interpolate the second output subset, the instructions are further executable by the one or more processors to cause the one or more processors to determine a change value based on the first subset and the first output subset; determine a weight value; modify the change value based on the weight value; and generate the second output subset based on the modified change value and a second subset of the first input version of the multiple latent image frames.

Example 45 includes the non-transitory computer-readable medium of Example 43, and where, to interpolate the second output subset, the instructions are further executable by the one or more processors to cause the one or more processors to perform a linear interpolation operation.

Example 46 includes the non-transitory computer-readable medium of any of Examples 41-45, and where the instructions are further executable by the one or more processors to cause the one or more processors to, for a second sampling operation of the multiple sampling operations: receive a second input version of the multiple latent image frames; perform the diffusion operation, based on the generative model, on the second input version of the multiple latent image frames to generate a second output version of the multiple latent image frames; and output the second output version of the multiple latent image frames.

Example 47 includes the non-transitory computer-readable medium of Example 46, where a first power consumption associated with performance of the first sampling operation is less than a second power consumption associated with performance of the second sampling operation.

Example 48 includes the non-transitory computer-readable medium of Example 46 or Example 47, where the second sampling operation is performed prior to the first sampling operation; and the second output version is provided as the first input version for the second sampling operation.

Example 49 includes the non-transitory computer-readable medium of Example 46 or Example 47, where the second sampling operation is performed after the first sampling operation; and the first output version is provided as the second input version for the second sampling operation.

Example 50 includes the non-transitory computer-readable medium of Example 49, and where the instructions are further executable by the one or more processors to cause the one or more processors to, for a third sampling operation of the multiple sampling operations: receive the second output version of the multiple latent image frames as a third input version of the multiple latent image frames; perform the diffusion operation, based on the generative model, on a first subset of the third input version of the multiple latent image frames to generate a third output subset of the multiple latent image frames; generate a fourth output subset of the multiple latent image frames based on the third input version of the multiple latent image frames and based on the third output subset of the multiple latent image frames; and output a third output version of the multiple latent image frames, the third output version including the third output subset and the fourth output subset.

Example 51 includes the non-transitory computer-readable medium of Example 50, where the multiple latent image frames include a subset of latent image frames; and each of the first subset of the first input version and the first subset of the third input version are associated with the subset of latent image frames of the multiple latent image frames.

Example 52 includes the non-transitory computer-readable medium of any of Examples 41-51, and where the instructions are further executable by the one or more processors to cause the one or more processors to encode, via a variational autoencoder (VAE), the input image frame to generate a latent representation of the input image frame; and decode a final version of the multiple latent image frames based on the multiple sampling operations to generate the multiple output image frames; and where the multiple output image frames include fourteen or more image frames associated with the input image frame.

Example 53 includes the non-transitory computer-readable medium of any of Examples 41-52, where the generative model is applied to perform a text-based video generation operation, a text-based video content editing operation, image-based video generation operation, a video enhancement operation, video compression, a data augmentation operation, or a combination thereof.

Example 54 includes the non-transitory computer-readable medium of any of Examples 41-53, and where the instructions are further executable by the one or more processors to cause the one or more processors to receive, from one or more cameras, image data associated with the input image frame.

Example 55 includes the non-transitory computer-readable medium of Example 54, where the multiple output image frames are generated at least partially based on the image data from the one or more cameras.

Example 56 includes the non-transitory computer-readable medium of Example 54 or Example 55, and where the instructions are further executable by the one or more processors to cause the one or more processors to receive, from an input device, an input that includes a request to generate video data including the multiple output image frames based on the image data from the one or more cameras.

Example 57 includes the non-transitory computer-readable medium of any of Examples 41-56, and where the instructions are further executable by the one or more processors to cause the one or more processors to output, to a display device, the multiple output image frames as video content.

Example 58 includes the non-transitory computer-readable medium of any of Examples 41-57, and where the instructions are further executable by the one or more processors to cause the one or more processors to transmit, via a modem, the multiple output image frames to a second device for output by the second device.

Example 59 includes the non-transitory computer-readable medium of any of Examples 41-58, and where the instructions are further executable by the one or more processors to cause the one or more processors to receive, from a microphone, an input signal that includes a request to generate the multiple output image frames; output, via a speaker, audio associated with the multiple output image frames; or a combination thereof.

Example 60 includes the non-transitory computer-readable medium of any of Examples 41-59, where the non-transitory computer-readable medium is integrated in a mobile phone, a tablet computer device, a wearable electronic device, a virtual reality headset, a mixed reality headset, an augmented reality headset, or a camera device.

According to Example 61, an apparatus includes means for obtaining an input image frame; means for generating, based on the input image frame, a time sequence of multiple latent image frames; means for performing a first sampling operation of multiple sampling operations, the means for performing the first sampling operation including: means for receiving a first input version of the multiple latent image frames; means for performing a diffusion operation, based on a generative model, on a first subset of the first input version of the multiple latent image frames to generate a first output subset of the multiple latent image frames; means for generating a second output subset of the multiple latent image frames based on the first input version of the multiple latent image frames and based on the first output subset of the multiple latent image frames; and means for outputting a first output version of the multiple latent image frames, the first output version including the first output subset and the second output subset; and means for outputting, based on the multiple sampling operations, multiple output image frames associated with the input image frame.

Example 62 includes the apparatus of Example 61, where the generative model includes an image-to-video generative model; the generative model has a U-Net architecture; the multiple output image frames is a time sequence of the multiple output image frames; or a combination thereof.

Example 63 includes the apparatus of Example 61 or Example 62, where the means for generating the second output subset of the multiple latent image frames includes means for interpolating the second output subset based on the first input version and the first output subset.

Example 64 includes the apparatus of Example 63, where the means for interpolating the second output subset includes: means for determining a change value based on the first subset and the first output subset; means for determining a weight value; means for modifying the change value based on the weight value; and means for generating the second output subset based on the modified change value and a second subset of the first input version of the multiple latent image frames.

Example 65 includes the apparatus of Example 63, where the means for interpolating the second output subset includes means for performing a linear interpolation operation.

Example 66 includes the apparatus of any of Examples 61-65, and where the apparatus includes means for performing a second sampling operation of the multiple sampling operations, the means for performing the second sampling operation includes: means for receiving a second input version of the multiple latent image frames; means for performing the diffusion operation, based on the generative model, on the second input version of the multiple latent image frames to generate a second output version of the multiple latent image frames; and means for outputting the second output version of the multiple latent image frames.

Example 67 includes the apparatus of Example 66, where a first power consumption associated with performance of the first sampling operation is less than a second power consumption associated with performance of the second sampling operation.

Example 68 includes the apparatus of Example 66 or Example 67, where the second sampling operation is performed prior to the first sampling operation; and the second output version is provided as the first input version for the second sampling operation.

Example 69 includes the apparatus of Example 66 or Example 67, where the second sampling operation is performed after the first sampling operation; and the first output version is provided as the second input version for the second sampling operation.

Example 70 includes the apparatus of Example 69, and where the apparatus further includes means for performing a third sampling operation of the multiple sampling operations, the means for performing the third sampling operation: means for receiving the second output version of the multiple latent image frames as a third input version of the multiple latent image frames; means for performing the diffusion operation, based on the generative model, on a first subset of the third input version of the multiple latent image frames to generate a third output subset of the multiple latent image frames; means for generating a fourth output subset of the multiple latent image frames based on the third input version of the multiple latent image frames and based on the third output subset of the multiple latent image frames; and means for outputting a third output version of the multiple latent image frames, the third output version including the third output subset and the fourth output subset.

Example 71 includes the apparatus of Example 70, where the multiple latent image frames include a subset of latent image frames; and each of the first subset of the first input version and the first subset of the third input version are associated with the subset of latent image frames of the multiple latent image frames.

Example 72 includes the apparatus of any of Examples 61-71, and where the apparatus further includes means for encoding the input image frame to generate a latent representation of the input image frame; and means for decoding a final version of the multiple latent image frames based on the multiple sampling operations to generate the multiple output image frames; and where the multiple output image frames include fourteen or more image frames associated with the input image frame.

Example 73 includes the apparatus of any of Examples 61-72, where the generative model is applied to perform a text-based video generation operation, a text-based video content editing operation, image-based video generation operation, a video enhancement operation, video compression, a data augmentation operation, or a combination thereof.

Example 74 includes the apparatus of any of Examples 61-73, and where the apparatus further includes means for generating image data associated with the input image frame.

Example 75 includes the apparatus of Example 74, where the multiple output image frames are generated at least partially based on the image data.

Example 76 includes the apparatus of Example 74 or Example 75, and where the apparatus further includes means for receiving an input that includes a request to generate video data including the multiple output image frames based on the image data from the one or more cameras.

Example 77 includes the apparatus of any of Examples 61-76, and where the apparatus further includes means for outputting, via a display device, the multiple output image frames as video content.

Example 78 includes the apparatus of any of Examples 61-77, and where the apparatus further includes means for transmitting, via a modem, the multiple output image frames to a second device for output by the second device.

Example 79 includes the apparatus of any of Examples 61-78, and where the apparatus further includes means for receiving, from a microphone, an input signal that includes a request to generate the multiple output image frames; means for outputting, via a speaker, audio associated with the multiple output image frames; or a combination thereof.

Example 80 includes the apparatus of any of Examples 61-79, where the apparatus includes a mobile phone, a tablet computer device, a wearable electronic device, a virtual reality headset, a mixed reality headset, an augmented reality headset, or a camera device.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
a memory configured to store a generative model; and
one or more processors configured to:
obtain an input image frame;
generate, based on the input image frame, a time sequence of multiple latent image frames;
for a first sampling operation of multiple sampling operations:
receive a first input version of the multiple latent image frames;
perform a diffusion operation, based on the generative model, on a first subset of the first input version of the multiple latent image frames to generate a first output subset of the multiple latent image frames;
generate a second output subset of the multiple latent image frames based on the first input version of the multiple latent image frames and based on the first output subset of the multiple latent image frames; and
output a first output version of the multiple latent image frames, the first output version including the first output subset and the second output subset; and
output, based on the multiple sampling operations, multiple output image frames associated with the input image frame.

2. The device of claim 1, wherein:
the generative model includes an image-to-video generative model;
the generative model has a U-Net architecture;
the multiple output image frames is a time sequence of the multiple output image frames; or
a combination thereof.

3. The device of claim 1, wherein, to generate the second output subset of the multiple latent image frames, the one or more processors are configured to interpolate the second output subset based on the first input version and the first output subset.

4. The device of claim 3, wherein, to interpolate the second output subset, the one or more processors are configured to:
determine a change value based on the first subset and the first output subset;
determine a weight value;
modify the change value based on the weight value; and
generate the second output subset based on the modified change value and a second subset of the first input version of the multiple latent image frames.

5. The device of claim 3, wherein, to interpolate the second output subset, the one or more processors are configured to perform a linear interpolation operation.

6. The device of claim 1, wherein the one or more processors are configured to, for a second sampling operation of the multiple sampling operations:
receive a second input version of the multiple latent image frames;
perform the diffusion operation, based on the generative model, on the second input version of the multiple latent image frames to generate a second output version of the multiple latent image frames; and
output the second output version of the multiple latent image frames.

7. The device of claim 6, wherein a first power consumption associated with performance of the first sampling operation is less than a second power consumption associated with performance of the second sampling operation.

8. The device of claim 6, wherein:
the second sampling operation is performed prior to the first sampling operation; and
the second output version is provided as the first input version for the second sampling operation.

9. The device of claim 6, wherein:
the second sampling operation is performed after the first sampling operation; and
the first output version is provided as the second input version for the second sampling operation.

10. The device of claim 9, wherein the one or more processors are configured to, for a third sampling operation of the multiple sampling operations:
receive the second output version of the multiple latent image frames as a third input version of the multiple latent image frames;
perform the diffusion operation, based on the generative model, on a first subset of the third input version of the multiple latent image frames to generate a third output subset of the multiple latent image frames;
generate a fourth output subset of the multiple latent image frames based on the third input version of the multiple latent image frames and based on the third output subset of the multiple latent image frames; and
output a third output version of the multiple latent image frames, the third output version including the third output subset and the fourth output subset.

11. The device of claim 10, wherein:
the multiple latent image frames include a subset of latent image frames; and
each of the first subset of the first input version and the first subset of the third input version are associated with the subset of latent image frames of the multiple latent image frames.

12. The device of claim 1, wherein:
the one or more processors are configured to:
encode, via a variational autoencoder (VAE), the input image frame to generate a latent representation of the input image frame; and
decode a final version of the multiple latent image frames based on the multiple sampling operations to generate the multiple output image frames; and
wherein the multiple output image frames include fourteen or more image frames associated with the input image frame.

13. The device of claim 1, wherein the generative model is applied to perform a text-based video generation operation, a text-based video content editing operation, image-based video generation operation, a video enhancement operation, video compression, a data augmentation operation, or a combination thereof.

14. The device of claim 1, further comprising:
one or more cameras coupled to the one or more processors and configured to generate image data associated with the input image frame; and
an input device configured to receive an input and provide the input to the one or more processors, wherein the input includes a request to generate video data including the multiple output image frames based on the image data from the one or more cameras.

15. The device of claim 1, further comprising:
a display device coupled to the one or more processors and configured to output the multiple output image frames as video content.

16. The device of claim 1, further comprising a modem coupled to the one or more processors, the modem configured to transmit the multiple output image frames to a second device for output by the second device.

17. The device of claim 1, further comprising:
a microphone configured to provide an input signal to the one or more processors.

18. The device of claim 17, wherein:
the one or more processors are configured to perform a speech to text conversion operation on the input to generate text data; and
the generative model is applied, based on the text data, to perform a text-based video generation operation or a text-based video content editing operation.

19. A method of operating a media device including a processor, the method comprising:
obtaining an input image frame;
generating, based on the input image frame, a time sequence of multiple latent image frames;
for a first sampling operation of multiple sampling operations:
receiving a first input version of the multiple latent image frames;
performing a diffusion operation, based on a generative model, on a first subset of the first input version of the multiple latent image frames to generate a first output subset of the multiple latent image frames;
generating a second output subset of the multiple latent image frames based on the first input version of the multiple latent image frames and based on the first output subset of the multiple latent image frames; and
outputting a first output version of the multiple latent image frames, the first output version including the first output subset and the second output subset; and
outputting, based on the multiple sampling operations, multiple output image frames associated with the input image frame.

20. A non-transitory computer-readable medium that stores instructions that are executable by one or more processors to cause the one or more processors to:
obtain an input image frame;
generate, based on the input image frame, a time sequence of multiple latent image frames;
for a first sampling operation of multiple sampling operations:
receive a first input version of the multiple latent image frames;
perform a diffusion operation, based on a generative model, on a first subset of the first input version of the multiple latent image frames to generate a first output subset of the multiple latent image frames;
generate a second output subset of the multiple latent image frames based on the first input version of the multiple latent image frames and based on the first output subset of the multiple latent image frames; and
output a first output version of the multiple latent image frames, the first output version including the first output subset and the second output subset; and
output, based on the multiple sampling operations, multiple output image frames associated with the input image frame.
